(19) United States
(12) Patent Application Publication
(10) Pub. No.: US 2025/0374137 A1
(43) Pub. Date: Dec. 4, 2025

(54) L1/L2 Mobility Serving Cell Change Indication

(71) Applicant: Telefonaktiebolaget LM Ericsson (publ), Stockholm (SE)

(72) Inventors: Pontus Wallentin, Linköping (SE); Icaro Leonardo Da Silva, Solna (SE); Ioanna Pappa, Stockholm (SE); Antonino Orsino, Kirkkonummi (FI)

(21) Appl. No.: 18/874,127

(22) PCT Filed: May 30, 2023
(86) PCT No.: PCT/SE2023/050526

§ 371 Date: Dec. 12, 2024

Related U.S. Application Data
(60) Provisional application No. 63/353,980, filed on Jun. 21, 2022.

(51) Int. Cl. H04W 36/04; H04L 1/1812; H04W 16/28; H04W 72/1273

(52) U.S. Cl. CPC H04W 36/04; H04L 1/1812; H04W 16/28; H04W 72/1273

(57) ABSTRACT

A method performed by a user equipment, UE, the method comprising: executing (601) a serving cell change procedure from a source cell provided by a first network node to a target cell provided by a second network node, wherein the serving cell change procedure is performed using lower layer signalling; and in response to executing the serving cell change procedure, performing (602) one or more of: (i) transmitting a serving cell change indication to the second network node indicating that the serving cell change has been executed; (ii) monitoring a downlink control channel in the target cell for scheduling of user data in a downlink to the UE; and (iii) transmitting a scheduling request in the target cell for scheduling of user data in an uplink from the UE.

### TECHNICAL FIELD

This disclosure relates to the field of telecommunication networks, and in particular relates to serving cell change from a source cell to a target cell.

### BACKGROUND

Lower Layer Signalling (e.g. Medium Access Control (MAC) Control Element (CE) with a Transmission Configuration Indication (TCI) State Indication Received by the User Equipment (UE)

A beam may correspond to a spatial direction in which a UE receives a signal, such as a reference signal and/or a synchronization signal(s). In existing 5G New Radio (NR) beam management procedures, the UE is configured via Radio Resource Control (RRC) signalling (e.g. a RRC Reconfiguration message) with a list of so-called Transmission Configuration Indication (TCI) state(s), where each TCI state has an identifier and is associated with a so-called Quasi-Co-Location (QCL) source. The QCL source configuration in a TCI state configuration is basically an indication of a reference signal identifier, which may either be a Synchronization Signal Block (SSB) identifier or a Channel State Information-Reference Signal (CSI-RS) resource identifier. When an activated TCI state is related to a physical channel having resources in time and frequency, like a Physical Downlink Control Channel (PDCCH)/Control Resource Set (CORESET), the UE monitors that physical channel assuming the same QCL properties as the indicated reference signal identifier and/or synchronization signal identifier. In other words, the QCL source in the TCI state configuration indicates the downlink beam on which the physical channel is being transmitted i.e. the downlink spatial direction in which the UE receives the physical channel. The information element (IE) in RRC is shown below, which defines the signalling for the configuration of a TCI-State and the QCL-Info IE within, where the QCL source is configured, as specified in 3^{rd} Generation Partnership Project (3GPP) TS 38.331 v17.0.0.

TCI-State information element

| -- ASN1START | |
|---|---|
| -- TAG-TCI -STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | ENUMERATED {typeA, typeB, typeC, |

```
  qcl-Type
typeD},
  ...
}
-- TAG-TCI-STATE-STOP
-- ASN1STOP
```

For the purpose of beam management, the UE is typically configured by the network to transmit Channel State Information (CSI) reports including measurements on SSB indexes/CSI-RS resource identifiers, such as L1-Reference Signal Received Power (RSRP) and/or Reference Signal Received Quality (RSRQ), as specified in 3GPP TS 38.211 v17.1.0. For example, a UE configured by the network with a set of TCI states, associated to physical channel configuration(s), may have a TCI state whose TCI-state ID=X activated (with QCL source configured as SSB index=A) at a point in time t0, for a given PDCCH configuration, meaning the UE is monitoring the scheduling information from the network in the downlink beam transmitting SSB index=A; when the UE transmits a CSI report, possibly indicating better SSBs than the SSB whose SSB index=A (e.g. an SSB index=B, configured as QCL source of another TCI-State ID=Y), the UE may receive a lower layer signalling (MAC CE) indicating that it is the TCI-State whose TCI-State ID=Y which shall be activated. These TCI states are associated to a serving cell, such as a Special Cell (SpCell), Primary Cell (PCell), Primary Secondary Cell Group (SCG) Cell (PSCell) or Secondary Cell (SCell).

The procedure for the UE to receive the MAC CE is defined as follows. The MAC entity at the UE indicates to the lower layers (L1 at the UE) which TCI state is being activated, so the UE expects that QCL-TypeD of a CSI-RS in a TCI state indicated by a MAC CE activation command for the CORESET is provided by a Synchronisation Signal (SS)/Physical Broadcast Channel (PBCH) block, as shown below.

[38.321]
5.18.5 Indication of TCI state for UE-specific PDCCH

The network may indicate a TCI state for PDCCH reception for a CORESET of a Serving Cell by sending the TCI State Indication for UE-specific PDCCH MAC CE described in clause 6.1.3.15.

The MAC entity shall:
1> if the MAC entity receives a TCI State Indication for UE-specific PDCCH MAC CE on a Serving Cell:
2> indicate to lower layers the information regarding the TCI State Indication for UE-specific PDCCH MAC CE.
   [38.213]

### 10.1UE Procedure for Determining Physical Downlink Control Channel Assignment

For a CORESET with index 0, the UE assumes that a DM-RS antenna port for PDCCH receptions in the CORESET is quasi co-located with
the one or more DL RS configured by a TCI state, where the TCI state is indicated by a MAC CE activation command for the CORESET, if any, or
. . .

For a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that QCL-TypeD of a CSI-RS in a TCI state indicated by a MAC CE activation command for the CORESET is provided by a SS/PBCH block
if the UE receives a MAC CE activation command for one of the TCI states, the UE applies the activation command in the first slot that is after slot

$$k + 3 \cdot {N}_{slot}^{subframe , μ}$$

slot where the UE would transmit a PUCCH with HARQ-ACK information for the PDSCH providing the activation command and u is the SCS configuration for the PUCCH. The active BWP is defined as the active BWP in the slot when the activation command is applied.

FIG. 1 illustrates the delays in beam management for applying the MAC CE indicating a new TCI state to be activated.

The UE applies the MAC CE at a point in time also assumed by the serving network node. The network and the UE need to have a common understanding as the network needs to start scheduling the UE in the newly indicated beam (i.e. according to the newly indicated TCI state) after the network assumes the UE has processed the MAC CE and/or after the network receives lower layer feedback such as a Hybrid Automatic Repeat Request (HARQ) Acknowledgement (Ack) associated to the MAC CE. An MAC-CE based TCI state switch delay is defined in 3GPP TS 38.133, as follows, for different assumptions.

[38.133]

### 8.10.3 MAC-CE Based TCI State Switch Delay

If the target TCI state is known, upon receiving PDSCH carrying MAC-CE activation command in slot n, UE shall be able to receive PDCCH with target TCI state of the serving cell on which TCI state switch occurs at the first slot that is after slot

$$n + {T}_{HARQ} + 3 {N}_{slot}^{subframe , μ} + {TO}_{k} * ( {T}_{first - SSB} + {T}_{SSB - proc} ) / NR$$

slot length. The UE shall be able to receive PDCCH with the old TCI state until slot n+T_{HARQ}

$$+ 3 {N}_{slot}^{subframe , μ} .$$

Where T_{HARQ} is the timing between DL data transmission and acknowledgement as specified in TS 38.213 [3];
T_{first-SSB} is time to first SSB transmission after MAC CE command is decoded by the UE;
T_{SSB-proc}=2 ms;
TOₖ=1 if target TCI state is not in the active TCI state list for PDSCH, 0 otherwise.

If the target TCI state is unknown, upon receiving PDSCH carrying MAC-CE activation command in slot n, UE shall be able to receive PDCCH with target TCI state of the serving cell on which TCI state switch occurs at the first slot that is after slot

$$n + {T}_{HARQ} + 3 {N}_{slot}^{subframe , μ} + {T}_{L 1 - RSRP} + {TO}_{uk} * ( {T}_{first - SSB} + {T}_{SSB - proc} ) / NR slot length .$$

The UE shall be able to receive PDCCH with the old TCI state until slot

$$n + {T}_{HARQ} + 3 {N}_{slot}^{subframe , μ} .$$

Where
T_{L1-RSRP}=0 in FR1 or when the TCI state switching not involving QCL-TypeD in FR2. Otherwise,
T_{L1-RSRP} is the time for Rx beam refinement in FR2, defined as
   T_{L1-RSRP_Measurement_Period_SSB} for SSB as specified in clause 9.5.4.1,
      with the assumption of M=1
      with T_{Report}=0
   T_{L1-RSRP_Measurement_Period_CSI-RS} for CSI-RS as specified in clause 9.5.4.2
      configured with higher layer parameter repetition set to ON
      with the assumption of M=1 for periodic CSI-RS
      for aperiodic CSI-RS if number of resources in resource set at least equal to MaxNumberRxBeam
      with T_{Report}=0
   T_{O}uk=1 for CSI-RS based L1-RSRP measurement, and 0 for SSB based L1-RSRP measurement when TCI state switching involves QCL-TypeD
   TOᵤₖ=1 when TCI state switching involves other QCL types only
   T_{first-SSB} is time to first SSB transmission after L1-RSRP measurement when TCI state switching involves QCL-TypeD;
   T_{first-SSB} is time to first SSB transmission after MAC CE command is decoded by the UE for other QCL types;
      The SSB shall be the QCL-TypeA or QCL-TypeC to target TCI state

### Further NR Mobility Enhancements in 3GPP Release 18

A new work item known as Further NR mobility enhancements is included as part of 3GPP Release 18 (Rel-18). This work item aims to, among other things, specify Layer 1 (L1)/Layer 2 (L2)-based inter-cell mobility. According to the Work Item Description (WID) RP-211586 (RP-211586, 3GPP work item description: Further enhancements on MIMO for NR, Samsung, 3GPP TSG RAN Meeting #92e, Electronic Meeting, Jun. 14-18, 2021), the following is included as one objective of the work.

| 1. | To specify mechanism and procedures of L1/L2 based inter-cell mobility for mobility latency | |
|---|---|---|
| | reduction: | |
| | ◯ | Configuration and maintenance for multiple candidate cells to allow fast application of |
| | | configurations for candidate cells [RAN2, RAN3] |
| | ◯ | Dynamic switch mechanism among candidate serving cells (including SpCell and |
| | | SCell) for the potential applicable scenarios based on L1/L2 signalling [RAN2, RAN1] |
| | ◯ | L1 enhancements for inter-cell beam management, including L1 measurement and |
| | | reporting, and beam indication [RAN1, RAN2] |

| | |
|---|---|
| - | Note 1: Early RAN2 involvement is necessary, including the possibility of further |
| | clarifying the interaction between this bullet with the previous bullet |

| | |
|---|---|
| ◯ | Timing Advance management [RAN1, RAN2] |
| ◯ | CU-DU interface signaling to support L1/L2 mobility, if needed [RAN3] |

Note 2: FR2 specific enhancements are not precluded, if any.
Note 3: The procedure of L1/L2 based inter-cell mobility are applicable to the following
scenarios:

| | |
|---|---|
| ▪ | Standalone, CA and NR-DC case with serving cell change within one CG |
| ▪ | Intra-DU case and intra-CU inter-DU case (applicable for Standalone |
| | and CA: no new RAN interfaces are expected) |
| ▪ | Both intra-frequency and inter-frequency |
| ▪ | Both FR1 and FR2 |
| ▪ | Source and target cells may be synchronized or non-synchronized |

According to the work item description RP-213565 (RP-213565, 3GPP work item description: Further NR mobility enhancements, MediaTek, 3GPP TSG RAN Meeting #94e, Electronic Meeting, Dec. 6-17, 2021), the following is written as part of the justification:

When the UE moves from the coverage area of one cell to another cell, at some point a serving cell
change needs to be performed. Currently serving cell change is triggered by L3 measurements and
is done by RRC signalling triggered Reconfiguration with Synchronisation for change of PCell and
PSCell, as well as release add for SCells when applicable. All cases involve complete L2 (and L1)
resets, leading to longer latency, larger overhead and longer interruption time than beam switch
mobility. The goal of L1/L2 mobility enhancements is to enable a serving cell change via L1/L2
signalling, in order to reduce the latency, overhead and interruption time.

### SUMMARY

There currently exist certain challenge(s). According to the work item description RP-211586 mentioned above, for the feature referred to in 3GPP as L1/L2 based inter-cell mobility, the overall procedure and signalling is still open. A goal of L1/L2 based inter-cell mobility is to reduce latency, overhead and interruption time. A challenge is therefore how to ensure that the data transfer in the target cell, including downlink and uplink scheduling of data, and switching of the data path performed by the target network node, such as a target distributed unit (DU), can be started as soon as the UE is able to monitor (or receive) a physical channel in a downlink beam of the target cell, indicated by the lower layer signalling to be defined for L1/L2 inter-cell mobility; or, in other words, as soon as the UE switches or activates the TCI state indicated in the lower layer signalling.

A first existing solution which is related to this problem, and which is illustrated in FIG. 2, is intra-cell beam management signalling. Here, the UE receives from a serving network node (serving gNB-DU) a MAC CE indicating the activation of a TCI state, transmits the associated HARQ feedback to the serving network node at a slot k (where Physical Uplink Control Channel (PUCCH) and/or Physical Uplink Shared Channel (PUSCH) is configured) and applies the MAC CE after a predefined amount of time units after the slot k the UE is supposed to send the HARQ feedback to the serving cell. Based on that, the UE starts to monitor the downlink beam (or spatial direction) whose SSB index and/or CSI-RS resource identifier has been indicated in the received MAC CE. The network node controlling the serving cell (such as a serving gNB-DU) is also aware of the delay requirement on the UE side for applying the MAC CE, so that this node controlling the serving cell (which has also transmitted the MAC CE) knows when the UE is able to receive a physical channel in the newly indicated beam.

However, this solution has problems because in L1/L2 based inter-cell mobility the UE is changing/switching beams (or TCI states, or QCL sources being monitored) from different cells, in some cases controlled by the same network node and in other cases controlled by different network node(s), e.g., different DU(s), as inter-DU intra-Central Unit (CU) L1/L2 based inter-cell mobility needs to be standardised. The uncertainty in the delay of the interfaces between the CU, source DU and target DU makes this more challenging.

A second existing solution, which is related to the problem, is the existing Reconfiguration With Sync/handover procedure in NR and Long Term Evolution (LTE). Here, the UE receives an RRC Reconfiguration message (L3 message) from the source cell including the IE Reconfiguration With Sync. The source cell is possibly controlled by a serving network node. Based on that RRC Reconfiguration message, the UE applies the message and transmits an RRCReconfigurationComplete message, according to the newly applied configuration in the handover command. However, this solution also has problems as it relies on a procedure leading to a MAC reset, which increases the interruption time, whereas one of the main goals of L1/L2 inter-cell mobility is to minimise the interruption time. In addition, this second existing solution relies on an RRC message over L3 (RRCReconfigurationComplete) to indicate to the target that the UE has applied the new configuration, which requires processing at the CU for the target during the execution, which would further delay the process of L1/L2 inter-cell mobility execution. It could be said that before the RRC Reconfiguration Complete message the UE transmits a random access preamble, which is also an uplink (UL) message. However, the preamble is transmitted for the purpose of UL synchronization and it does not indicate that the UE is successfully operating according to the new configuration, so that the network does not schedule user plane data until it receives the RRC Reconfiguration Complete. This is summarised in 3GPP TS 38.401 version 17.0.0, section 8.2.1.1 Inter-gNB-DU Mobility, as shown in FIG. 3, which shows signalling between Source DU, CU and Target DU for Layer 3 (L3) handover. Step 9 in FIG. 3 indicates that downlink (DL) packets are sent to the UE (and uplink packets are sent from the UE, which are forwarded to the gNB-CU through the target gNB-DU) only after the target gNB-DU sends an UL RRC MESSAGE TRANSFER message to the gNB-CU to convey the received RRCReconfigurationComplete message, which increases the latency.

Certain aspects of the disclosure and their embodiments may provide solutions to these or other challenges.

According to a first aspect, there is provided a method performed by a UE. The method comprises executing a serving cell change procedure from a source cell provided by a first network node to a target cell provided by a second network node. The serving cell change procedure is performed using lower layer signalling. In response to executing the serving cell change procedure, the method further comprises performing one or more of: (i) transmitting a serving cell change indication to the second network node indicating that the serving cell change has been executed; (ii) monitoring a downlink control channel in the target cell for scheduling of user data in a downlink to the UE; and (iii) transmitting a scheduling request in the target cell for scheduling of user data in an uplink from the UE.

According to a second aspect, there is provided a method performed by a first network node. The method comprises determining whether a UE has executed a serving cell change procedure from a source cell provided by the first network node to a target cell provided by a second network node. The serving cell change procedure is performed using lower layer signalling.

According to a third aspect, there is provided a method performed by a second network node. The method comprises determining whether a UE has executed a serving cell change procedure from a source cell provided by a first network node to a target cell provided by the second network node. The serving cell change procedure is performed using lower layer signalling.

According to a fourth aspect, there is provided a method performed by a third network node. The method comprises determining whether a UE has executed a serving cell change procedure from a source cell provided by a first network node to a target cell provided by a second network node. The serving cell change procedure is performed using lower layer signalling.

According to a fifth aspect, there is provided a UE configured to execute a serving cell change procedure from a source cell provided by a first network node to a target cell provided by a second network node. The serving cell change procedure is performed using lower layer signalling. The UE is further configured to, in response to executing the serving cell change procedure, perform one or more of: (i) transmitting a serving cell change indication to the second network node indicating that the serving cell change has been executed; (ii) monitoring a downlink control channel in the target cell for scheduling of user data in a downlink to the UE; and (iii) transmitting a scheduling request in the target cell for scheduling of user data in an uplink from the UE.

According to a sixth aspect, there is provided a UE comprising a processor and a memory. The memory contains instructions executable by said processor whereby said UE is operative to execute a serving cell change procedure from a source cell provided by a first network node to a target cell provided by a second network node. The serving cell change procedure is performed using lower layer signalling. The UE is further operative to, in response to executing the serving cell change procedure, perform one or more of: (iv) transmitting a serving cell change indication to the second network node indicating that the serving cell change has been executed; (v) monitoring a downlink control channel in the target cell for scheduling of user data in a downlink to the UE; and (vi) transmitting a scheduling request in the target cell for scheduling of user data in an uplink from the UE.

According to a seventh aspect, there is provided a first network node configured to determine whether a UE has executed a serving cell change procedure from a source cell provided by the first network node to a target cell provided by a second network node. The serving cell change procedure is performed using lower layer signalling.

According to a seventh aspect, there is provided a first network node comprising a processor and a memory. The memory contains instructions executable by said processor whereby said first network node is operative to determine whether a UE has executed a serving cell change procedure from a source cell provided by the first network node to a target cell provided by a second network node. The serving cell change procedure is performed using lower layer signalling.

According to an eighth aspect, there is provided a second network node configured to determine whether a UE has executed a serving cell change procedure from a source cell provided by a first network node to a target cell provided by the second network node. The serving cell change procedure is performed using lower layer signalling.

According to a ninth aspect, there is provided a second network node comprising a processor and a memory. The memory contains instructions executable by said processor whereby said second network node is operative to determine whether a UE has executed a serving cell change procedure from a source cell provided by a first network node to a target cell provided by the second network node. The serving cell change procedure is performed using lower layer signalling.

According to a tenth aspect, there is provided a third network node configured to determine whether a UE has executed a serving cell change procedure from a source cell provided by a first network node to a target cell provided by a second network node. The serving cell change procedure is performed using lower layer signalling.

According to an eleventh aspect, there is provided a third network node comprising a processor and a memory, said memory containing instructions executable by said processor whereby said third network node is operative to determine whether a UE has executed a serving cell change procedure from a source cell provided by a first network node to a target cell provided by a second network node. The serving cell change procedure is performed using lower layer signalling.

Certain embodiments may provide one or more of the following technical advantages. In particular, the proposed solution enables the UE and the network, during a L1/L2 based inter-cell mobility serving cell change procedure from a source cell to a target cell, to start the data transfer as soon as the UE has started to receive the downlink beam as indicated by the lower layer signalling that indicated the L1/L2 based inter-cell mobility serving cell change procedure to the UE.

The solution has advantages over the existing solutions, including the signalling for intra-cell beam management and Reconfiguration with sync (also known as handover or L3 handover), as it can be applied for L1/L2 based inter-cell mobility and also where the source and target cells may be controlled by different nodes where the uncertainty in the delay of the inter-node interfaces needs to be taken into account.

### BRIEF DESCRIPTION OF THE DRAWINGS

Some of the embodiments contemplated herein will now be described more fully with reference to the accompanying drawings, in which:

FIG. 1 is a schematic illustrating delays in beam management;

FIG. 2 is a signalling diagram illustrating intra-cell beam management signalling;

FIG. 3 is a signalling diagram illustrating a Layer 3 handover;

FIG. 4 is a signalling diagram in accordance with some embodiments;

FIG. 5 is a signalling diagram in accordance with some embodiments;

FIG. 6 is a flow chart illustrating a method performed by a UE in accordance with some embodiments;

FIG. 7 is a flow chart illustrating a method performed by a first network node in accordance with some embodiments;

FIG. 8 is a flow chart illustrating a method performed by a second network node in accordance with some embodiments;

FIG. 9 is a flow chart illustrating a method performed by a third network node in accordance with some embodiments;

FIG. 10 is a schematic illustrating an exemplary system structure in which the techniques described herein can be implemented;

FIG. 11 is a signalling diagram in accordance with some embodiments;

FIG. 12 is a flow chart illustrating a method performed by a UE in accordance with some embodiments;

FIG. 13 depicts an Access Success procedure;

FIG. 14 illustrates a communication system in accordance with some embodiments;

FIG. 15 illustrates a wireless device or UE in accordance with some embodiments;

FIG. 16 illustrates a network node in accordance with some embodiments;

FIG. 17 is a block diagram illustrating a virtualization environment; and

FIG. 18 shows a communication diagram of a host communicating via a network node with a UE over a partially wireless connection in accordance with some embodiments.

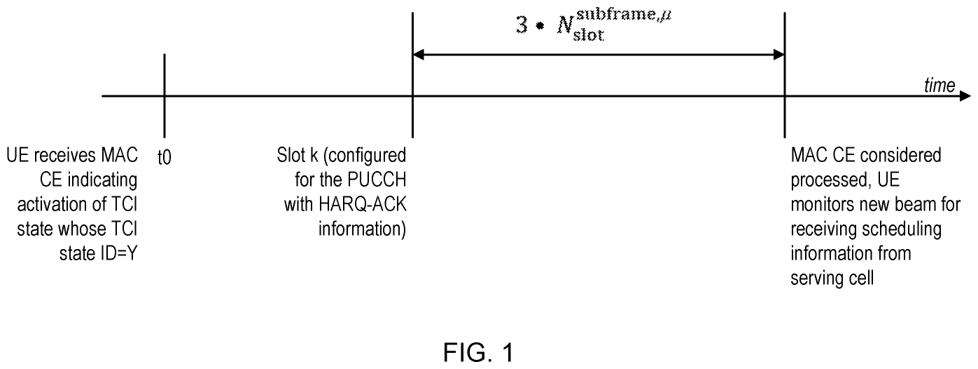

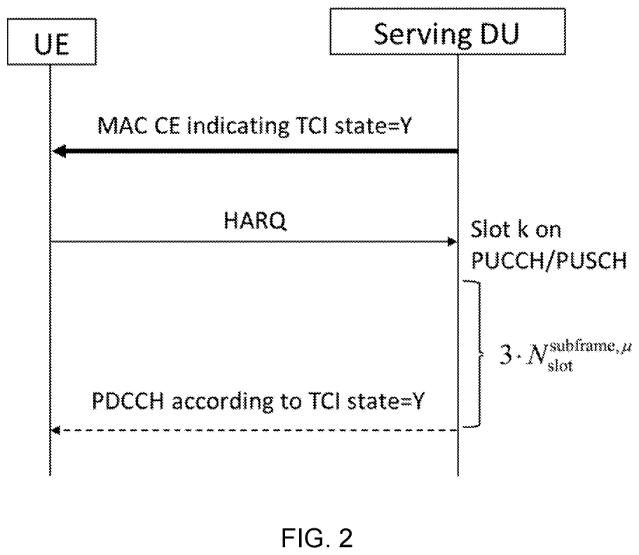

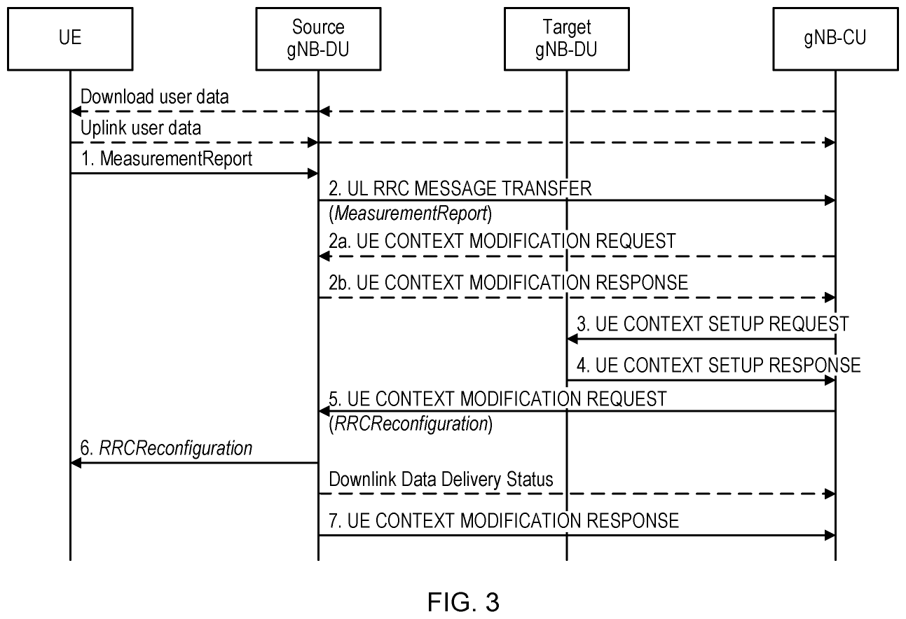

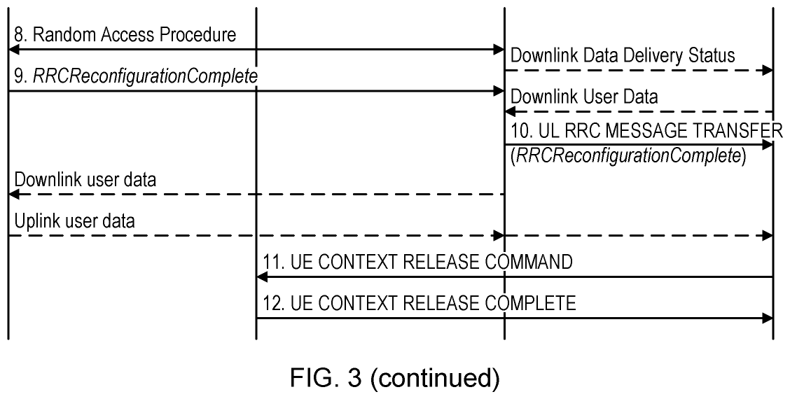

### DETAILED DESCRIPTION

Some of the embodiments contemplated herein will now be described more fully with reference to the accompanying drawings. Embodiments are provided by way of example to convey the scope of the subject matter to those skilled in the art.

The solutions of the present disclosure are divided into two main approaches, Approach A and Approach B, and these are described and illustrated below. It will be noted that each approach has a number of optional features and features that are alternatives to each other. It will also be noted that, unless otherwise expressly excluded or indicated as incompatible, features and steps of Approach A may be incorporated into Approach B. Likewise, unless otherwise expressly excluded or indicated as incompatible, features and steps of Approach B may be incorporated into Approach A. Furthermore, a hybrid approach can be adopted that uses one or more steps or features from Approach A, and one or more steps or features from Approach B.

### Approach A

Approach A comprises methods for a User Equipment (UE) with at least one configuration of an L1/L2 based inter-cell mobility candidate cell, to execute an L1/L2 based inter-cell mobility serving cell change procedure from a source cell (provided by a source/serving network node) to a target cell (provided by a target network node), and in response transmitting an L1/L2 based inter-cell mobility serving cell change indication in an uplink (UL) channel of the target cell (i.e. to the target network node that provides the target cell).

The execution of the L1/L2 based inter-cell mobility serving cell change procedure may be triggered by the reception of lower layer signalling indicating to the UE the L1/L2 based inter-cell mobility serving cell change procedure.

The L1/L2 based inter-cell mobility serving cell change indication may be sent using lower layer signalling (e.g. a MAC CE, Downlink Control Information (DCI), i.e. a message which is not an RRC message but a message on a protocol layer lower than RRC).

After transmitting the L1/L2 based inter-cell mobility serving cell change indication in the target cell (i.e. to the target network node), the UE starts to monitor a downlink physical control channel (e.g. PDCCH/CORESET) of the target cell. The downlink physical control channel carries at least one Downlink Control Information (DCI) indicating the scheduling of user plane data from the target cell to the UE.

The method can also comprise the UE transmitting to a source network node or a serving network node, such as a source gNB, a source DU, a serving gNB or Serving DU, an UL feedback message. The sending of the UL feedback message (e.g. a Hybrid Automatic Repeat Request-HARQ message) can be triggered by the UE in response to the successful reception of the lower layer signalling indicating to the UE the L1/L2 based inter-cell mobility serving cell change procedure.

Approach A also comprises methods for a source network node, such as a source gNB or a source DU, or a serving network node such as a serving DU, to control the execution of a L1/L2 based inter-cell mobility serving cell change procedure of a UE from a source cell (provided by the source network node) to a target cell. The source network node or serving network node is also referred to as the “first network node” herein. The method comprises the source/serving network node determining that the UE has successfully completed (i.e. completed the execution of) the L1/L2 based inter-cell mobility serving cell change procedure. The source/serving network node can determine this by any one or more of:
receiving from the UE an UL feedback message (e.g. a Hybrid Automatic Repeat Request-HARQ message), the sending of which can be triggered by the UE in response to the successful reception of the lower layer signalling indicating to the UE the L1/L2 based inter-cell mobility serving cell change procedure; and
receiving an indication from a target network node (e.g. a target DU, via a Central Unit (CU) associated to the serving DU), indicating that the L1/L2 based inter-cell mobility serving cell change procedure has been successfully completed. In this case, the target network node can be aware that the process has been successfully completed by receiving from the UE the L1/L2 based inter-cell mobility serving cell change indication in the target cell.

Upon determining that the UE has successfully completed (i.e. completed the execution of) the L1/L2 based inter-cell mobility serving cell change procedure, the Serving DU may indicate that to the CU (so CU may indicate to the target DU).

Approach A also comprises methods for a target network node, such as a target gNB, a target DU, or a target gNB-DU, to control the execution of a L1/L2 based inter-cell mobility serving cell change procedure of a UE from a source cell to a target cell (provided by the target network node). The target network node is also referred to as the “second network node” herein. The target network node determines that the UE has completed the L1/L2 based inter-cell mobility serving cell change procedure. The target network node can determine this by any one or more of:
receiving a L1/L2 based inter-cell mobility serving cell change indication in the target cell by the UE; and
transmitting to a network node, such as a third network node (e.g. a serving CU), an indication of (completion of) a L1/L2 based inter-cell mobility serving cell change procedure for a UE (e.g., an Access Success message); and
receiving from a network node, such as a third network node (e.g. the serving CU), an indication of (completion of) a L1/L2 based inter-cell mobility serving cell change procedure for a UE; and in response, transmitting in a downlink physical control channel (e.g. PDCCH/CORESET) of the target cell at least one Downlink Control Information (DCI) indicating the scheduling of user plane data from the target cell to the UE.

Approach A also comprises methods for a third network node (or serving network node), such as a (serving) Central Unit (CU), (serving) gNB-CU, to control the execution of a L1/L2 based inter-cell mobility serving cell change procedure of a UE from a source cell to a target cell. The method comprises one or both of:
the third network node receiving, from the first network node (e.g. source network node or serving network node), an indication of a L1/L2 based inter-cell mobility serving cell change procedure for a UE; and transmitting to a target DU an indication for a L1/L2 based inter-cell mobility serving cell change procedure for the UE; and
receiving an indication from a second/target network node (e.g. a target DU, via the CU associated to the serving DU), indicating that the L1/L2 based inter-cell mobility serving cell change procedure has been successfully completed. For example, the received indication may be an Access Success message. The target network node may be aware that the process has been successfully completed by receiving from the UE the L1/L2 based inter-cell mobility serving cell change indication in the target cell.
   In response to receiving the indication, the third network node may transmit Downlink User Data to the target network node, (such as target DU).

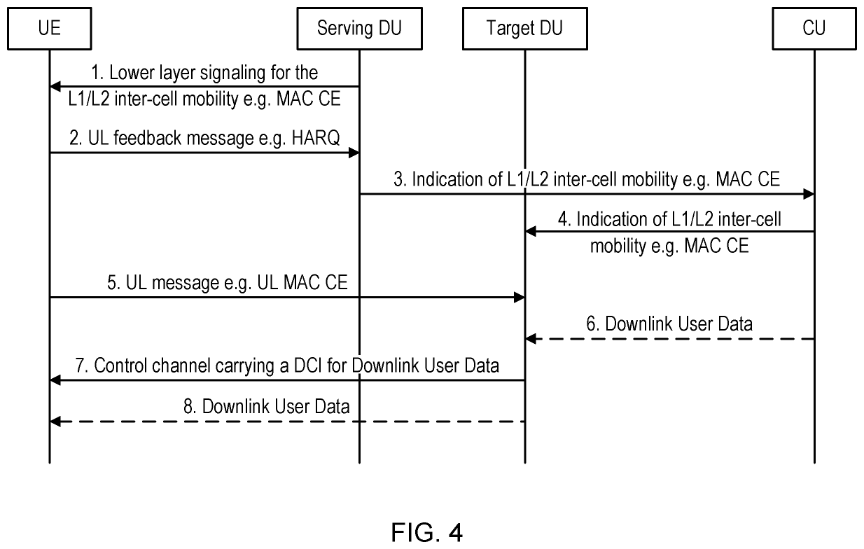

FIG. 4 is a signalling diagram that illustrates an embodiment of Approach A, where the first/source network node is in this example a serving DU (also known a source DU), the second/target network node is a target DU, and the third network node is a CU (also known as serving CU). It will be noted from the above discussion of Approach A that not all steps are shown in FIG. 4, and not all of the steps that are shown in FIG. 4 are mandatory or required, and further steps/signals may exist between the steps/signals shown in FIG. 4. For example, step 3 may be triggered by the Serving DU based on the Serving DU having performed step 1. As another example, step 5 may be performed without the Target DU having performed step 4.

### Approach B

Approach B may differ from Approach A. For example, in Approach B, the UE may, in response to the execution of a L1/L2 based inter-cell mobility serving cell change procedure from a source cell to a target cell, transmit a scheduling request to the target cell for transmitting UL User Data (e.g., instead of transmitting an L1/L2 based inter-cell mobility serving cell change indication in an UL channel of the target cell, as in Approach A). Furthermore, the target network node may determine that the UE has completed the L1/L2 based inter-cell mobility serving cell change procedure based on this received scheduling request.

Approach B comprises methods for a User Equipment (UE) with at least one configuration of an L1/L2 based inter-cell mobility candidate cell, to execute an L1/L2 based inter-cell mobility serving cell change procedure from a source cell (provided by a source/serving network node) to a target cell (provided by a target network node) by receiving lower layer signalling indicating to the UE the L1/L2 based inter-cell mobility serving cell change procedure. In response to the execution of the L1/L2 based inter-cell mobility serving cell change procedure, the UE performs one or more of:
starting the monitoring of a downlink physical control channel (e.g. PDCCH, CORESET) of the target cell after a first number of time units (denoted K1). The downlink physical control channel carries at least one Downlink Control Information (DCI) indicating the scheduling of user plane data from the target cell to the UE; and
transmitting a scheduling request to the target cell for transmitting UL User Data after a second number of time units (denoted K2).

Approach B also comprises methods for a source network node, such as a source gNB, a source DU, a serving DU, or a source CU, to control the execution of a L1/L2 based inter-cell mobility serving cell change procedure of a UE from a source cell (provided by the source network node) to a target cell and to determine that the UE has completed the L1/L2 based inter-cell mobility serving cell change procedure. The source network node or serving network node is also referred to as the “first network node” herein. The source network node can control the execution of a L1/L2 based inter-cell mobility serving cell change procedure of a UE from the source cell to the target cell and determine that the UE has completed the L1/L2 based inter-cell mobility serving cell change procedure by performing any one or more of:
transmitting to the UE an indication using lower layer signalling to the UE the L1/L2 based inter-cell mobility serving cell change procedure, and
receiving an indication which means that the UE has completed the L1/L2 based inter-cell mobility serving cell change procedure. The indication that the UE has completed the L1/L2 based inter-cell mobility serving cell change procedure may correspond to an UL feedback message (e.g. a Hybrid Automatic Repeat Request-HARQ message). The UL feedback message can be triggered by the UE in response to the successful reception of the lower layer signalling indicating to the UE the L1/L2 based inter-cell mobility serving cell change procedure.

Upon determining that the UE has successfully completed (i.e. completed the execution of) the L1/L2 based inter-cell mobility serving cell change procedure, the source network node may indicate this to the CU, and the CU may indicate this to the target network node.

Approach B comprises methods for a target network node, such as a target gNB, a target DU, or a target CU, to control the execution of a L1/L2 based inter-cell mobility serving cell change procedure of a UE from a source cell to a target cell (provided by the target network node) and determine that the UE has completed the L1/L2 based inter-cell mobility serving cell change procedure. The target network node is also referred to as the “second network node” herein. The target network node can control the execution of a L1/L2 based inter-cell mobility serving cell change procedure of a UE from a source cell to a target cell and determine that the UE has completed the L1/L2 based inter-cell mobility serving cell change procedure by one or more of:
receiving a scheduling request for transmitting UL User Data; and
receiving, from a third network node (e.g. the serving CU), an indication of a L1/L2 based inter-cell mobility serving cell change procedure for a UE; and in response, transmitting, after a third number of timer units (denoted K3), in a downlink physical control channel (e.g. PDCCH/CORESET) of the target cell at least one Downlink Control Information (DCI) indicating the scheduling of user plane data from the target cell to the UE.

Approach B also comprises methods for a third network node (or serving network node), such as a Central Unit (CU), CU-gNB, to control the execution of a L1/L2 based inter-cell mobility serving cell change procedure of a UE from a source cell to a target cell. The method can comprise one or both of:
the CU receiving from the first network node (e.g. a serving DU) an indication of a L1/L2 based inter-cell mobility serving cell change procedure for a UE; and transmitting to a target network node (e.g. target DU) an indication for a L1/L2 based inter-cell mobility serving cell change procedure for the UE; and
receiving an indication from a target network node (e.g. a target DU, via the CU associated to the serving DU), indicating that the L1/L2 based inter-cell mobility serving cell change procedure has been successfully completed. The target network node can be aware that the process has been successfully completed by receiving from the UE the L1/L2 based inter-cell mobility serving cell change indication in the target cell. In response to receiving the indication, the third network node (CU) can transmit Downlink User Data to the Target DU.

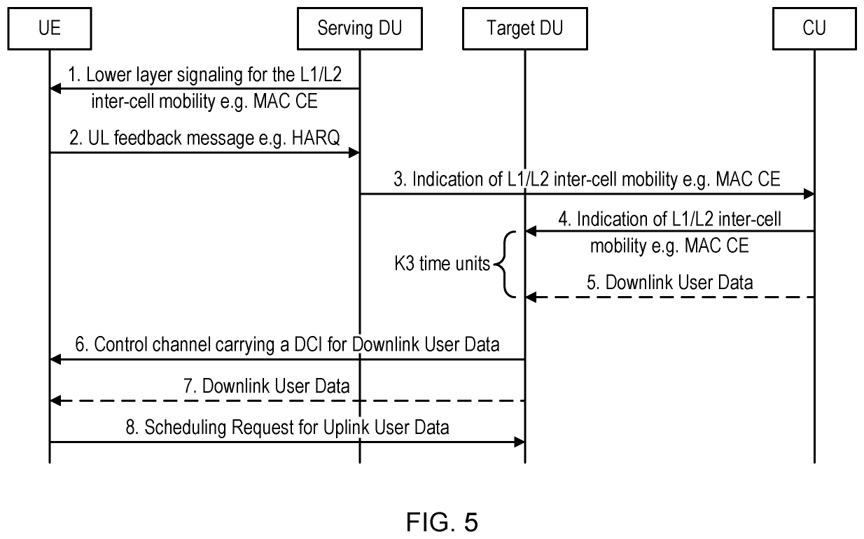

FIG. 5 is a signalling diagram that illustrates an embodiment of Approach B, where the first/source network node is in this example a serving DU (also known as source DU), the second/target network node is a target DU and the third network node is a CU (also known as serving CU). It will be noted from the above discussion of Approach B that not all steps are shown in FIG. 5, and not all of the steps that are shown in FIG. 5 are mandatory or required, and further steps/signals may exist between the steps/signals shown in FIG. 5. For example, step 3 of FIG. 5 may be triggered by the Serving DU based on the Serving DU having performed step 1 of FIG. 5. As another example, step 6 may be performed without the Target DU having performed step 3/4.

The following paragraphs summarise various features of the above methods in the UE, source network node, target network node and third network node according to Approaches A and B.

Approach A provides methods for a UE configured with at least one L1/L2 based inter-cell mobility candidate cell, to execute a L1/L2 based inter-cell mobility serving cell change procedure from a source cell to a target cell, comprising: in response to executing a L1/L2 based inter-cell mobility serving cell change procedure, transmitting a L1/L2 based inter-cell mobility serving cell change indication.

Approach A provides methods for a source network node, such as a source DU, to control the execution of a L1/L2 based inter-cell mobility serving cell change procedure of a UE from a source cell to a target cell, comprising: determining that the UE has completed the L1/L2 based inter-cell mobility serving cell change procedure.

Approach A provides methods for a target network node, such as a target DU, to control the execution of a L1/L2 based inter-cell mobility serving cell change procedure of a UE from a source cell to a target cell, comprising: determining that the UE has completed the L1/L2 based inter-cell mobility serving cell change procedure.

Approach A provides methods for a third network node, such as a serving CU, to control the execution of a L1/L2 based inter-cell mobility serving cell change procedure of a UE from a source cell to a target cell.

Approach B provides methods for a UE configured with at least one L1/L2 based inter-cell mobility candidate cell, to execute a L1/L2 based inter-cell mobility serving cell change procedure from a source cell to a target cell, and performing one of: starting the monitoring of a control channel (e.g. PDCCH, CORESET) of the target cell after a first number of time units (K1); and transmitting a scheduling request in the target cell after a second number of time units (K2).

Approach B provides methods for a source network node, such as a source DU, to control the execution of a L1/L2 based inter-cell mobility serving cell change procedure of a UE from a source cell to a target cell, and determining that the UE has completed the L1/L2 based inter-cell mobility serving cell change procedure, wherein the determination is one of: receiving, from the target network node, or a third network node, an indication that the L1/L2 based inter-cell mobility serving cell change procedure has completed; and receiving, from the UE, an acknowledgment in response to a lower layer signalling indicating to the UE the L1/L2 based inter-cell mobility serving cell change procedure only after that the L1/L2 based inter-cell mobility serving cell change procedure has been completed.

Approach B provides methods for a target network node, such as a target DU, to control the execution of a L1/L2 based inter-cell mobility serving cell change procedure of a UE from a source cell to a target cell, and determining that the UE has completed the L1/L2 based inter-cell mobility serving cell change procedure; wherein the determination can be receiving, from the UE, a scheduling request including a L1/L2 based inter-cell mobility serving cell change indication in the target cell.

Approach B provides methods for a third network node, such as a serving CU, to control the execution of a L1/L2 based inter-cell mobility serving cell change procedure of a UE from a source cell to a target cell.

Certain embodiments may provide one or more of the following technical advantage(s). In particular, the proposed solution enables the UE and the network, during a L1/L2 based inter-cell mobility serving cell change procedure from a source cell to a target cell, to start the data transfer as soon as the UE has started to receive the downlink beam as indicated by the lower layer signalling that indicated the L1/L2 based inter-cell mobility serving cell change procedure to the UE.

The solution has advantages over the existing solutions, including the signalling for intra-cell beam management and Reconfiguration with sync (also known as handover or L3 handover), as it can be applied for L1/L2 based inter-cell mobility and also where the source and target cells may be controlled by different nodes where the uncertainty in the delay of the inter-node interfaces needs to be taken into account.

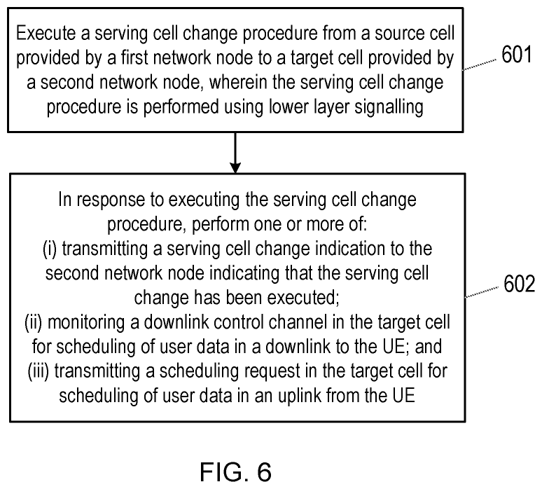

FIG. 6 illustrates a method, in accordance with some embodiments, performed by a UE. The method comprises, at step 601, executing a serving cell change procedure from a source cell provided by a first network node to a target cell provided by a second network node. The serving cell change procedure is performed using lower layer signalling. The lower layer signalling may be a Physical Layer and/or a MAC Layer. The lower layer signalling may be Layer 1 and/or Layer 2 signalling. In some embodiments, the lower layer signalling is signalling in a layer below a RRC layer.

The method of FIG. 6 further comprises, in response to executing the serving cell change procedure, performing at step 602 one or more of: (i) transmitting a serving cell change indication to the second network node indicating that the serving cell change has been executed; (ii) monitoring a downlink control channel in the target cell for scheduling of user data in a downlink to the UE; and (iii) transmitting a scheduling request in the target cell for scheduling of user data in an uplink from the UE.

In some embodiments, at step 602, the UE transmits a serving cell change indication to the second network node indicating that the serving cell change has been executed ((i) of step 602); and monitors a downlink control channel in the target cell for scheduling of user data in a downlink to the UE ((ii) of step 602). Some of these embodiments correspond to Approach A (described above). The serving cell change indication may be sent using lower layer signalling. The serving cell change indication may be one or more of: a MAC CE; a Random Access (RA) preamble; a Scheduling Request (SR); a CSI report; a RRC layer message; an RRCReconfigurationComplete message; and a Sounding Reference Signal (SRS).

In some embodiments, at step 602, the UE transmits a scheduling request in the target cell for scheduling of user data in an uplink from the UE ((iii) of step 602); and monitors a downlink control channel in the target cell for scheduling of user data in a downlink to the UE ((ii) of step 602). Some of these embodiments correspond to Approach B (described above). The scheduling request may be transmitted a predetermined time period (K2) after executing the serving cell change procedure.

The monitoring of the downlink control channel may be started a predetermined time period (K1) after executing the serving cell change procedure. Monitoring the downlink control channel may comprise monitoring for DCI.

In some embodiments, the method of FIG. 6 further comprises receiving lower layer signalling relating to the serving cell change procedure to enable the UE to execute the serving cell change procedure. The method of FIG. 6 may further comprise sending a feedback message to the first network node after receiving the lower layer signalling relating to the serving cell change procedure. The feedback message may be a HARQ message.

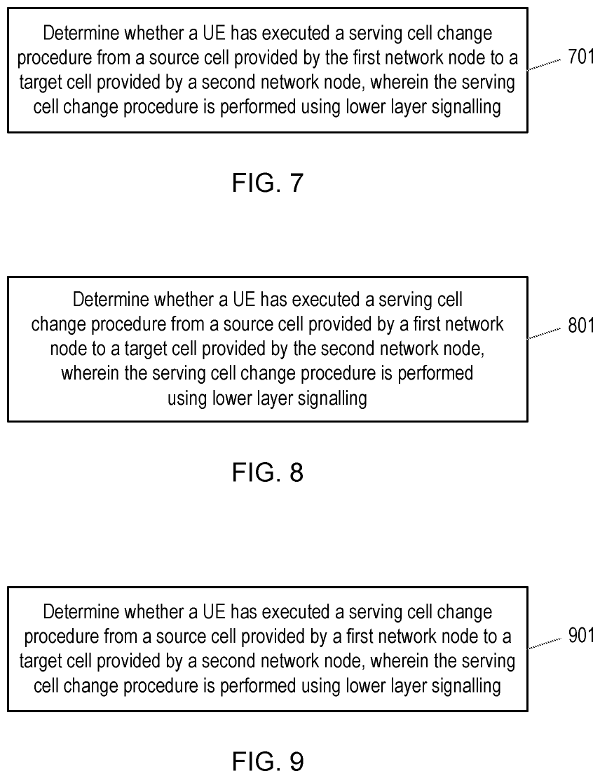

In some embodiments, the UE is (pre-) configured with at least one candidate cell for the serving cell change procedure (e.g. pre-configured with at least one configuration of an L1/L2 based inter-cell mobility candidate cell). FIG. 7 illustrates a method, in accordance with some embodiments, performed by a first network node. The first network node may be a source network node or a serving network node.

The method comprises, at step 701, determining whether a UE has executed a serving cell change procedure from a source cell provided by the first network node to a target cell provided by a second network node. The serving cell change procedure is performed using lower layer signalling. The lower layer signalling may be a Physical Layer and/or a MAC Layer. The lower layer signalling may be a Layer 1 and/or Layer 2 signalling. In some embodiments, the lower layer signalling may be signalling in a layer below a RRC layer.

In some embodiments, step 701 comprises determining that the UE has executed the serving cell change procedure if: (i) an indication is received from the second network node or a third network node that the serving cell change procedure has been completed; or (ii) a feedback message is received from the UE that indicates that the UE has received lower layer signalling relating to the serving cell change procedure. The feedback message may be a HARQ message.

In some embodiments, the method of FIG. 7 further comprises sending lower layer signalling relating to the serving cell change procedure to enable the UE to execute the serving cell change procedure.

In some embodiments, the UE is (pre-) configured with at least one candidate cell for the serving cell change procedure (e.g. pre-configured with at least one configuration of an L1/L2 based inter-cell mobility candidate cell).

FIG. 8 illustrates a method, in accordance with some embodiments, performed by a second network node. The second network node may be a target network node. The method comprises, at step 801, determining whether a UE has executed a serving cell change procedure from a source cell provided by a first network node to a target cell provided by the second network node. The serving cell change procedure is performed using lower layer signalling. The lower layer signalling may be a Physical Layer and/or a MAC Layer. The lower layer signalling may be Layer 1 and/or Layer 2 signalling. The lower layer signalling may be signalling in a layer below a RRC layer.

In some embodiments, step 801 comprises determining that the UE has executed the serving cell change procedure if: (i) a serving cell change indication is received from the UE indicating that the serving cell change has been executed; or (ii) a scheduling request is received from the UE to schedule user data in an uplink from the UE; or (iii) an indication is received from a third network node indicating that the serving cell change has been executed. The serving cell change indication may be sent using lower layer signalling. The serving cell change indication may be one or more of: a MAC Control Element; an RA preamble; a Scheduling Request; a CSI report; a RRC layer message; an RRCReconfigurationComplete message; and an SRS.

The scheduling request may be received a predetermined time period (K2) after executing the serving cell change procedure.

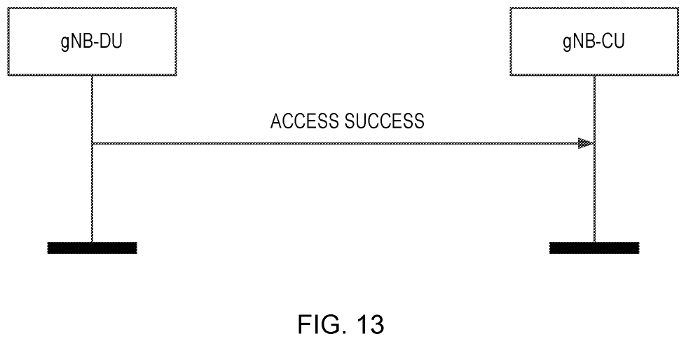

In some embodiments, the method of FIG. 8 further comprises transmitting an indication to the third network node indicating that the serving cell change has been executed. The indication transmitted to the third network node may be an Access Success message, e.g., as described with reference to FIG. 13.

In some embodiments, the method of FIG. 8 further comprises transmitting a downlink control channel to the UE for scheduling of user data in a downlink to the UE. The downlink control channel may comprise Downlink Control Information. The downlink control channel may be transmitted to the UE a predetermined time period (K3) after determining that the UE has executed the serving cell change procedure.

The method of FIG. 8 may further comprise obtaining user data; and forwarding the user data to a host or a user equipment.

In some embodiments, the UE is (pre-) configured with at least one candidate cell for the serving cell change procedure (e.g. pre-configured with at least one configuration of an L1/L2 based inter-cell mobility candidate cell).

FIG. 9 illustrates a method, in accordance with some embodiments, performed by a third network node. The third network node may be a serving network node. The method comprises, at step 901, determining whether a UE has executed a serving cell change procedure from a source cell provided by a first network node to a target cell provided by a second network node. The serving cell change procedure is performed using lower layer signalling. The lower layer signalling may be a Physical Layer and/or an MAC Layer.

In some embodiments, step 901 of FIG. 9 comprises determining that the UE has executed the serving cell change procedure if: (i) an indication is received from the first network node indicating that the serving cell change has been executed; or (ii) an indication is received from the second network node indicating that the serving cell change has been executed.

The serving cell change indication received from the second network node may be an Access Success message, e.g., as described with reference to FIG. 13.

In some embodiments, if it is determined that the UE has executed the serving cell change procedure due to an indication being received from the second network node, the method further comprises sending an indication to the first network node indicating that the serving cell change has been executed.

In some embodiments, if it is determined that the UE has executed the serving cell change procedure due to an indication being received from the first network node, the method further comprises sending an indication to the second network node indicating that the serving cell change has been executed. The lower layer signalling may be Layer 1 and/or Layer 2 signalling. The lower layer signalling may be signalling in a layer below an RRC layer.

The serving cell change indication may be received using lower layer signalling. The serving cell change indication may be one or more of: an MAC Control Element; an RA preamble; a Scheduling Request; a CSI report; a RRC layer message; an RRCReconfigurationComplete message; and an SRS.

In some embodiments, if it is determined that the UE has executed the serving cell change procedure, the method further comprises sending user data for the UE to the second network node.

In some embodiments, the method of FIG. 9 further comprises obtaining user data; and forwarding the user data to a host or a user equipment.

In some embodiments, the UE is (pre-) configured with at least one candidate cell for the serving cell change procedure (e.g. pre-configured with at least one configuration of an L1/L2 based inter-cell mobility candidate cell).

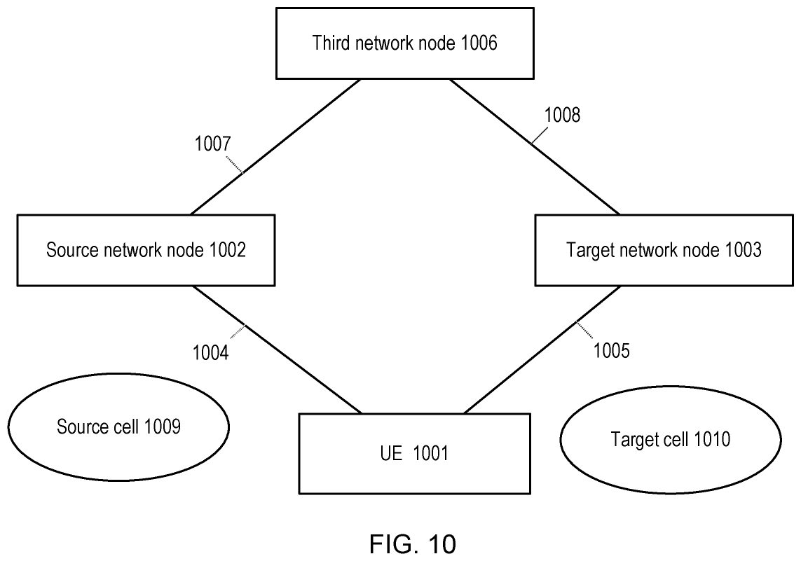

FIG. 10 illustrates an exemplary system structure in which the techniques described herein can be implemented.

As shown in FIG. 10, a User Equipment (UE) 1001, which can also be referred to as a wireless terminal, a mobile terminal, a wireless device, a terminal device, etc. and which can be a cellular smartphone, can be connected to communication network via a network node. In FIG. 10, several network nodes are shown: a network node that the UE 1001 is currently connected to (the source network node 1002), a network node (target network node 1003) that the UE 1001 to be connected to after a handover from the source network node 1002 and a third network node 1006. The UE 1001 communicates with the source network node 1002 over a wireless interface 1004, the UE 1001 communicates with the target network node 1003 over a wireless interface 1005. The third network node 1006 can communicate with the source network node 1002 and the target network node 1003 via wireless interfaces 1007 and 1008 respectively.

In the context of a mobility procedure for the UE 1001, such as a L1/L2 based inter-cell mobility serving cell change procedure, the source network node 1002, sometimes also referred to as the serving network node, controls a source cell 1009 and the target network node 1003 controls a target cell 1010. One or both of source network node 1002 and target network node 1003 may be a radio access network (RAN) node or base station such as a gNB, or, for example in case the system uses a distributed CU/DU RAN architecture, the source network node 1002 and/or target network node 1003 can be a distributed unit, sometimes known as either gNB-DU or DU. Hence the source network node 1002 would correspond to a source DU, which can also be known as a serving DU, and the target network node 1003 would correspond to a target DU. In this implementation, both the source network node 1002 and the target network node 1003 are connected to the third network node 1006, which can be referred to as a serving network node.

In addition, the third network node 1006 may be, for example in case of a distributed CU/DU RAN architecture, a central unit, CU, which can be referred to as the serving CU, known as either a gNB-CU, CU, gNB-CU-Control Plane (gNB-CU-CP) or gNB-CU-User Plane (gNB-CU-UP). Alternatively the third network node 1006 can be a core network node in the core network of the communication network, such as a User Plane Function, UPF or an Access and Mobility Management Function, AMF. The interfaces 1007, 1008 between the third network node 1006 and the source network node 1002 and the target network node 1003 respectively may be, in the case of a distributed CU/DU RAN architecture, an F1, F1-U, F1-C type of interface, or an NG type of interface.

It is noted that the present disclosure uses the term “L1/L2 based inter-cell mobility” as used in the Work Item Description in 3GPP, although it also interchangeably uses the terms “L1/L2 mobility”, “L1-mobility”, “L1 based mobility”, “L1/L2-centric inter-cell mobility” and “L1/L2 inter-cell mobility”. Even though 3GPP has not yet decided how L1/L2 based inter-cell mobility should be standardised, the basic principle is that the UE receives a lower layer signalling (i.e. L1/L2 layer signalling) from the network indicating to the UE a change of its serving cell (e.g. change of PCell, from a source to a target PCell), possibly with a change of beam to be monitored for a control channel, e.g. a change of Transmission Configuration Indication (TCI) state. Here, lower layer signalling refers to a message/signalling of a lower layer protocol than the RRC layer (which is part of Layer 3 or L3 of the protocol stack). Thus, a lower layer protocol refers to a lower layer protocol in the air interface protocol stack compared to the RRC protocol, for example Medium Access Control (MAC) is considered a lower layer protocol to RRC as it is “below” RRC in the air interface protocol stack, and in this case a lower layer signalling/message may correspond to a MAC Control Element (MAC CE). The MAC layer is part of Layer 2 or L2 of the protocol stack. Another example of a lower layer protocol is Layer 1 (or Physical Layer, L1), and in this case a lower layer signalling/message may correspond to Downlink Control Information (DCI). In a multi-beam scenario, a cell can be associated to multiple SSBs, and during a half-frame, different SSBs may be transmitted in different spatial directions (i.e. using different beams, spanning the coverage area of a cell). Similar reasoning may be applicable to CSI-RS resources, which may also be transmitted in different spatial directions.

The following terms and phrases are used throughout this disclosure:
“L1/L2 based inter-cell mobility candidate cell”—this is also referred to as a (L1/L2 based inter-cell mobility) candidate target cell, and is a (neighbour) cell, which is configured for being a potential target cell during a L1/L2 based inter-cell mobility serving cell change procedure;
“L1/L2 based inter-cell mobility serving cell change procedure”—this refers to the process of a UE changing its serving cell from a source cell to a candidate target cell
“Source cell”—this is also referred to as a serving cell, and is the cell serving the UE prior to the serving cell change procedure, the source cell is provided by a source network node;
“Target cell”—this is the cell that is the target for the UE in the serving cell change procedure, the target cell is provided by a target network node;
“L1/L2 based inter-cell mobility serving cell change indication”—this is a message/signal/indication that is sent by a UE to a target network node that provides the target cell, and that informs the target network node that the serving cell change procedure has been completed;
“Lower layer signalling indicating to the UE the L1/L2 based inter-cell mobility serving cell change procedure”—this is a message/signal/indication that is sent by the source network node to the UE to provide the UE with the information required for the serving cell change procedure. The signalling being ‘lower layer’ means that the signalling is at a layer of the protocol stack below the RRC layer, for example signalling in L1 and/or L2. Put another way, the lower layer signalling indicating to the UE the L1/L2 based inter-cell mobility serving cell change procedure, is not RRC signalling, or signalling in Layer 3 or above.
“UL feedback message”—this is a message/signal/indication that is sent by a UE to a source network node in response to the UE receiving the information required for the serving cell change procedure.

### Approach A

The techniques according to Approach A are now described in more detail.

In a UE that has at least one configuration of a L1/L2 based inter-cell mobility candidate cell, the UE executes the L1/L2 based inter-cell mobility serving cell change procedure from a source cell to a target cell, and in response to the serving cell change procedure the UE transmits a L1/L2 based inter-cell mobility serving cell change indication in the target cell and/or in the source cell.

In some embodiments, the L1/L2 based inter-cell mobility serving cell change indication in the target cell is a lower layer message, such as a MAC Control Element (CE), a random access (RA) preamble, a Scheduling Request (SR), a channel state information (CSI) report, or a Sounding Reference Signal (SRS). A lower layer message in this context is a message of a protocol entity which is below RRC in the protocol stack e.g. Packet Data Convergence Protocol (PDCP), Radio Link Control (RLC), MAC, PHY. L1 messages are all lower layer messages compared to RRC messages.

In some embodiments, the execution of the L1/L2 based inter-cell mobility serving cell change procedure is triggered by the reception of a lower layer signalling indicating to the UE the L1/L2 based inter-cell mobility serving cell change procedure.

In some embodiments, executing the L1/L2 based inter-cell mobility serving cell change procedure comprises the UE applying the lower layer signalling indicated to the UE in the L1/L2 based inter-cell mobility serving cell change procedure, and the UE starts to operate according to the configuration of the target cell, which comprises the UE monitoring the Transmission Configuration Information (TCI) state indicated in the lower layer signalling.

In some embodiments, after transmitting the L1/L2 based inter-cell mobility serving cell change indication in the target cell (to the target network node), the UE can start to monitor a downlink physical control channel (e.g. PDCCH/CORESET) of the target cell. The downlink physical control channel carries at least one Downlink Control Information (DCI) indicating the scheduling of user plane data from the target cell to the UE.

In some embodiments, the L1/L2 based inter-cell mobility serving cell change indication in the target cell may be one or more of:
a new field, bit, or structure within a lower layer message, e.g. a field in a MAC CE;
a lower layer message indicating the L1/L2 based inter-cell mobility serving cell change indication (e.g., when this is in response of a lower layer signalling indicating to the UE the L1/L2 based inter-cell mobility serving cell change procedure or when this is only used for L1/L2 based inter-cell mobility). In one example, if the lower layer message indicating the L1/L2 based inter-cell mobility serving cell change indication is a MAC CE, a logical channel can be associated to it, so that both UE and target network node know the message carrying the indication.

In some embodiments, the L1/L2 based inter-cell mobility serving cell change indication in the source cell can be a lower layer acknowledgement (e.g., MAC/HARQ ACK/NACK, or RLC ACK/NACK) in response to the lower layer signalling indicating to the UE the L1/L2 based inter-cell mobility serving cell change procedure, and the UE may send the serving cell change indication to the network only upon completion of the L1/L2 based inter-cell mobility serving cell change procedure.
In some examples, upon reception of the lower layer signalling indicating to the UE the L1/L2 based inter-cell mobility serving cell change procedure (e.g. MAC CE), the UE can transmit a HARQ ACK in the target cell derived from the indication in the command, where the HARQ ACK corresponds to the L1/L2 based inter-cell mobility serving cell change indication. As an example, the HARQ ACK can be sent in the target cell in an UL channel (e.g. PUSCH) according to a configuration of the target cell, so that when the UE receives lower layer signalling indicating to the UE the L1/L2 based inter-cell mobility serving cell change procedure, the UE applies the target cell configuration before transmitting the HARQ ACK to the target cell;
In some examples, upon reception of lower layer signalling indicating to the UE the L1/L2 based inter-cell mobility serving cell change procedure (e.g. MAC CE), the UE can transmit a HARQ ACK to the source cell, as a way to indicate to the source that the command has been successfully received. As an example, the HARQ ACK can be sent to the source in an UL channel (e.g. PUSCH) according to a configuration of the source cell, i.e. the UE's current configuration, so that when the UE receives the lower layer signalling indicating to the UE the L1/L2 based inter-cell mobility serving cell change procedure, the UE can first send the HARQ ACK to the source cell before it applies the target cell configuration.
   Upon reception of the HARQ ACK, the serving DU can indicate to the CU that the UE has received the lower layer signalling indicating to the UE the L1/L2 based inter-cell mobility serving cell change procedure. The CU may indicate that to the target DU so the target DU becomes aware of an incoming UE (which has been previously configured).
In some examples, the UE can determine to either transmit the lower layer acknowledgement to the source cell or to the target cell, depending on whether it is a HARQ ACK or a HARQ NACK. If it is a HARQ ACK, the UE can transmit it in the target cell, as a way to indicate to the target cell the procedure is successful procedure. If it is a HARQ NACK, the UE can transmit it to the source cell, as a way to indicate the reception and/or processing of the lower layer signalling indicating to the UE the L1/L2 based inter-cell mobility serving cell change procedure (e.g. MAC CE) was not successful. It should be noted that this does not preclude the solution of the UE transmitting the HARQ ACK in the source cell, and the L1/L2 based inter-cell mobility serving cell change indication in the target cell.

In some embodiments, after the UE transmits the L1/L2 based inter-cell mobility serving cell change indication, the UE can start to monitor a downlink control channel (e.g. CORESET, PDCCH) according to a configuration of a L1/L2 based inter-cell mobility candidate cell.

In some embodiments, the UE can receive a configuration of a L1/L2 based inter-cell mobility candidate cell, and the configuration can indicate whether or not the UE is to transmit in the target cell the L1/L2 based inter-cell mobility serving cell change indication upon execution of a L1/L2 based inter-cell mobility serving cell change procedure to the first L1/L2 based inter-cell mobility candidate cell. For example, if the UE executes L1/L2 mobility for the first L1/L2 based inter-cell mobility candidate cell and the indication is present, the UE can transmit the L1/L2 based inter-cell mobility serving cell change indication in the target cell; otherwise, if the indication is absent, the UE does not transmit the L1/L2 based inter-cell mobility serving cell change indication in the target cell (and possibly starts to monitor a control channel in the target cell without sending the indication beforehand).
At the network side, the cell in which the UE is to transmit the indication is a configured candidate cell of a target network node (e.g. a target DU) which is not the source network node (e.g. source DU or serving DU). The network (e.g. the third network node, such as the CU, or a target network node, such as a target (candidate) DU) can configure that, as the network knows which candidates are of the source network node, and which candidates are not (which may be transparent to the UE).
At the network side, the cell in which the UE is not to transmit the indication is a configured candidate cell of the source network node, such as source/serving DU. The network (e.g. the third network node, e.g. CU, or the target network node, such as target candidate DU) can configure that, as the network knows which candidates are of the source network node.

In some embodiments, the UE can receive a configuration of a L1/L2 based inter-cell mobility candidate cell, with the configuration indicating whether or not the UE is to transmit the L1/L2 based inter-cell mobility serving cell change indication to the source cell upon completion of a L1/L2 based inter-cell mobility serving cell change procedure to the first L1/L2 based inter-cell mobility candidate cell. For example, if the UE executes L1/L2 mobility for the first L1/L2 based inter-cell mobility candidate cell and the indication is present, the UE can transmit the L1/L2 based inter-cell mobility serving cell change indication in the source cell only after that L1/L2 based inter-cell mobility serving cell change procedure has been completed; otherwise, if the indication is absent, the UE can transmit the lower layer acknowledgment in the source cell right away after receiving the lower layer signalling indicating to the UE the L1/L2 based inter-cell mobility serving cell change procedure from the source cell.

In some embodiments, the UE can transmit the L1/L2 based inter-cell mobility serving cell change indication using at least one UL scheduling grant configuration provided by the network, e.g. provided during the preparation phase for configuring the UE with at least one L1/L2 based inter-cell mobility candidate cell. The UL scheduling grant configuration may comprise one of more of: time, frequency and/or coding resources for transmitting UL information on an UL channel such as Physical Uplink Shared Channel (PUSCH).
The at least one UL scheduling grant configuration may be provided by the network before the execution of the L1/L2 based inter-cell mobility serving cell change procedure, e.g. in an RRC message, associated to the configuration of a L1/L2 based inter-cell mobility candidate cell.
In addition or alternatively, the at least one UL scheduling grant configuration may be provided by the network upon the execution of the L1/L2 based inter-cell mobility serving cell change procedure, e.g. with or within the lower layer signalling triggering the execution of L1/L2 based inter-cell mobility serving cell change procedure, like a MAC CE including the UL scheduling grant configuration or activating it which is multiplexed with the MAC CE triggering the execution of the L1/L2 based inter-cell mobility serving cell change procedure.
In addition or alternatively, the at least one UL scheduling grant configuration may be provided by the network before the execution of the L1/L2 based inter-cell mobility serving cell change procedure e.g. in an RRC message, associated to the configuration of a L1/L2 based inter-cell mobility candidate cell as a set of configuration(s) e.g. A, B, C. Then, the lower layer signalling (e.g. MAC CE) indicating the L1/L2 based inter-cell mobility serving cell change procedure received by the UE can also indicate one of the configurations within the set of configuration(s).

In some embodiments, the UE can receive, from a source network node, lower layer signalling indicating to the UE the L1/L2 based inter-cell mobility serving cell change procedure, such as a Medium Access Control layer indication, such as a MAC Control Element, MAC CE, or a physical layer indication, such as a Downlink Control Information, DCI, transmitted on a physical downlink control channel, PDCCH.

A source network node (or first network node), such as a source gNB, a source DU or a source CU, can control the execution of a L1/L2 based inter-cell mobility serving cell change procedure of a UE from a source cell to a target cell and determine that the UE has completed the L1/L2 based inter-cell mobility serving cell change procedure.

In some embodiments, the source network node can determine that the UE has completed the L1/L2 based inter-cell mobility serving cell change procedure by receiving an indication from a target network node, such as the target DU, and/or a third network node, such as the CU, indicating that the L1/L2 based inter-cell mobility serving cell change procedure has been completed.

In some embodiments, the source network node can determine that the UE has completed the L1/L2 based inter-cell mobility serving cell change procedure when receiving a L1/L2 based inter-cell mobility serving cell change indication in the source cell.

In some embodiments, the L1/L2 based inter-cell mobility serving cell change indication can comprise the source network node receiving an indication from the UE after the UE has completed the L1/L2 based inter-cell mobility serving cell change procedure. The indication received from the UE may be a lower layer acknowledgment (e.g., MAC ACK or NACK, or RLC ACK) in response to the lower layer signalling indicating to the UE the L1/L2 based inter-cell mobility serving cell change procedure, and the UE sends the indication to the network only upon completion of the L1/L2 based inter-cell mobility serving cell change procedure.

In some embodiments, the source network node transmits, to the target network node, or a third network node, an indication of a L1/L2 based inter-cell mobility serving cell change procedure for the UE. The indication may further include an identification of the target cell and/or the TCI state.

A target network node (or second network node), such as a target gNB, a target DU, or a target CU, can control the execution of a L1/L2 based inter-cell mobility serving cell change procedure of a UE from a source cell to a target cell, and determine that the UE has completed the L1/L2 based inter-cell mobility serving cell change procedure.

In some embodiments, the target network node can determine that the UE has completed the L1/L2 based inter-cell mobility serving cell change procedure by receiving a L1/L2 based inter-cell mobility serving cell change indication in the target cell.

In some embodiments, the L1/L2 based inter-cell mobility serving cell change indication is a lower layer message, such as a MAC Control Element (CE), a random access (RA) preamble, a Scheduling Request (SR), a channel state information (CSI) report, and/or a Sounding Reference Signal (SRS). A lower layer message in this context is a message of a protocol entity which is below RRC in the protocol stack, e.g. PDCP, RLC, MAC, PHY, L1 messages are all lower layer messages compared to RRC messages.

In some embodiments, the L1/L2 based inter-cell mobility serving cell change indication may be explicit or implicit. In case of an explicit indication, the L1/L2 based inter-cell mobility serving cell change indication is a new field, bit, or structure within an existing lower layer message. Otherwise, in case of an implicit indication, the L1/L2 based inter-cell mobility serving cell change indication can be the reception of the lower layer message itself (e.g., when this is in response to lower layer signalling indicating to the UE the L1/L2 based inter-cell mobility serving cell change procedure or when this is only used for L1/L2 based inter-cell mobility).

In some embodiments, the L1/L2 based inter-cell mobility serving cell change indication is an RRC layer message, such as an RRCReconfiguration message.

In some embodiments, the target network node transmits, to a source network node, or a third network node, an indication that UE has completed the L1/L2 based inter-cell mobility serving cell change procedure.

In some embodiments, the target network node determines that the UE has completed the L1/L2 based inter-cell mobility serving cell change procedure by the target network node receiving, from a source network node, such as the target DU, or a third network node, such as the CU, an indication that UE has completed the L1/L2 based inter-cell mobility serving cell change procedure.

In some embodiments, after the target network node receives the L1/L2 based inter-cell mobility serving cell change indication, the target network node can perform one of more of:
start scheduling information in a control channel (e.g. PDCCH, CORESET) for the UE in the DL for the target cell of the UE's executed L1/L2 based inter-cell mobility serving cell change procedure;
monitor at least one UL control channel for scheduling request(s) to be transmitted by the UE in the target cell.

In some embodiments, the target network node receives, from the source network node, or a third network node, an indication of a L1/L2 based inter-cell mobility serving cell change procedure for a UE. The indication may further include an identification of the target cell and/or the TCI state. In response, the target network node may be prepared to receive the L1/L2 based inter-cell mobility serving cell change indication.

A third network node (or serving network node), such as a (serving) Central Unit (CU), (serving) gNB-CU, can control the execution of a L1/L2 based inter-cell mobility serving cell change procedure of a UE from a source cell to a target cell.

In some embodiments, the third network node can receive, from the source network node, an indication of a L1/L2 based inter-cell mobility serving cell change procedure for a UE. The indication may further include an identification of the target cell and/or the TCI state. In response, the third network node may transmit, to the target network node, an indication of the UE execution or UE preparation of the L1/L2 based inter-cell mobility serving cell change procedure.

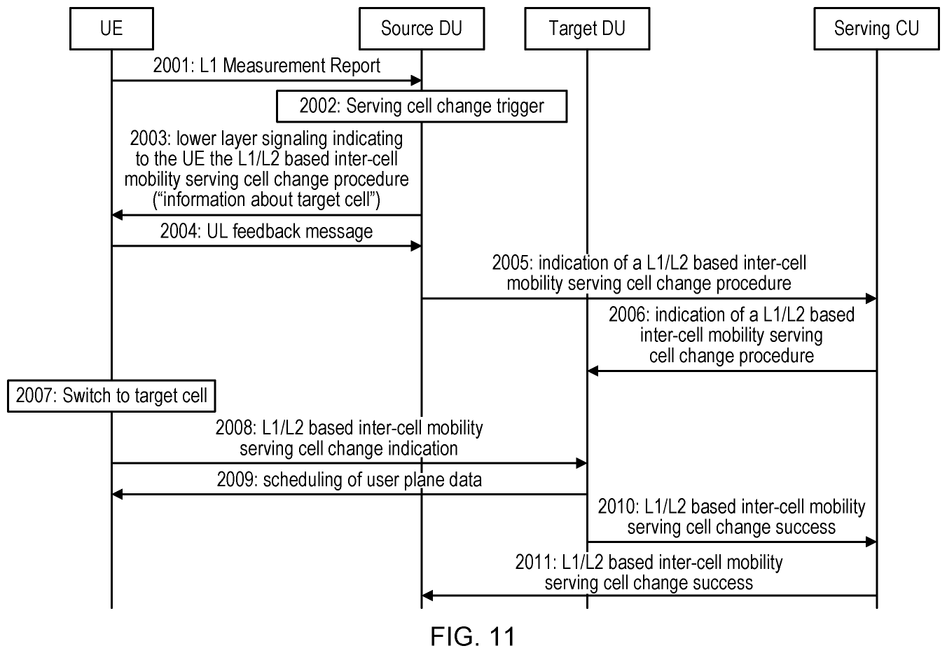

FIG. 11 is a message sequence chart showing one embodiment of Approach A.

FIG. 11 shows the signalling between a UE, a source network node, a target network node and a third network node. In the example shown in FIG. 11, the source network node is a source Distributed Unit, DU, also known as gNB-DU, in a distributed CU/DU RAN architecture, and the target network node is a target DU, also known as gNB-DU, in a distributed CU/DU RAN architecture. The third network node is a Serving Central Unit, CU, also known as gNB-CU, CU-CP, or gNB-CU-CP, in a distributed CU/DU RAN architecture.

The main steps in FIG. 11 are as follows.

Step 2001. The UE is connected with the source DU in the source cell. The UE is configured with at least one L1/L2 based inter-cell mobility candidate cell and performs measurements on candidate target cells. In this example, the UE transmits a lower layer measurement report for at least one candidate target cell to the source DU. The lower layer measurement report may be any of a CSI report, an L1 report or a MAC layer report.
Step 2002. The source DU triggers the execution of a L1/L2 based inter-cell mobility serving cell change procedure of the UE from the source cell to a target cell. In this example, the trigger is based in the reception of the measurement report from the UE. In another example, the trigger could be based on another event, such as an uplink measurement of a signal received by the UE, or be based on a configuration in the source DU itself.
Step 2003. The source DU transmits, to the UE, lower layer signalling indicating to the UE the L1/L2 based inter-cell mobility serving cell change procedure, including information about the target cell 1010, such as a cell identity, e.g. Physical Cell Identity (PCI), and/or a TCI state. In one example, the lower layer signalling indicating to the UE the L1/L2 based inter-cell mobility serving cell change procedure is a Medium Access Control (MAC) layer indication, such as a MAC Control Element, MAC CE. In another example, the lower layer signalling indicating to the UE the L1/L2 based inter-cell mobility serving cell change procedure is a physical layer indication, such as a Downlink Control Information, DCI, transmitted on a physical downlink control channel, PDCCH.
Step 2004. This step is optional. In response to the received lower layer signalling indicating to the UE the L1/L2 based inter-cell mobility serving cell change procedure, the UE may transmit, to the source DU, an uplink feedback message, such as a lower layer acknowledgement message, e.g. a HARQ ACK.
Step 2005. This step is optional. The source DU transmits, to the serving CU, an indication of a L1/L2 based inter-cell mobility serving cell change procedure for the UE. The indication may further include an identification of the target cell and/or the TCI state. The transmission of this indication may be triggered by reception of the UL feedback from the UE or, alternatively, be transmitted after the source DU has transmitted the lower layer signalling indicating to the UE the L1/L2 based inter-cell mobility serving cell change procedure to the UE.
Step 2006. This step is optional. In response to receiving the indication of a L1/L2 based inter-cell mobility serving cell change procedure for the UE, the serving CU transmits, to the target DU, an indication of a L1/L2 based inter-cell mobility serving cell change procedure for the UE. The indication may further include an identification of the target cell and/or the TCI state. The target DU becomes thus aware that the UE is about to switch to the target cell controlled by the target DU.
Step 2007. In response to the reception of the lower layer signalling indicating to the UE the L1/L2 based inter-cell mobility serving cell change procedure, the UE performs an L1/L2 based inter-cell mobility serving cell change procedure from the source cell to the target cell, including switching to the target cell according to the information received in the lower layer signalling indicating to the UE the L1/L2 based inter-cell mobility serving cell change procedure. The UE, in order to indicate to the source cell that the L1/L2 based inter-cell mobility serving cell change procedure has been completed, upon receipt of the lower layer signalling indicating to the UE the L1/L2 based inter-cell mobility serving cell change procedure, may delay the acknowledgement of this lower layer message only after the L1/L2 based inter-cell mobility serving cell change procedure has been completed.
Step 2008. The UE transmits, to the target DU, a message, referred to as L1/L2 based inter-cell mobility serving cell change indication in the target cell. In one example, the L1/L2 based inter-cell mobility serving cell change indication is a random access (RA) preamble. In another example, it is a MAC Control Element (MAC CE). In yet another example, it is a Scheduling Request (SR). In yet another example, it is a channel state information (CSI) report. In yet another example, it is a Sounding Reference Signal (SRS). In yet another example, it is an RRC message, such as an RRCReconfigurationComplete message. In yet another example, the UE does not transmit a request to the target DU. In one example, the L1/L2 based inter-cell mobility serving cell change indication includes UE identification information to identify itself for the target DU, such as the UE's target cell Cell-Radio Network Temporary Identifier (C-RNTI) or a new type of temporary UE identification allocated, e.g. by the target DU, during preparation of the L1/L2 based inter-cell mobility serving cell change procedure and provided in the lower layer signalling indicating to the UE the L1/L2 based inter-cell mobility serving cell change procedure. In one example, when the L1/L2 based inter-cell mobility serving cell change indication is a RA preamble, the RACH resource used for the RA preamble is used as a UE identification information. After transmitting the L1/L2 based inter-cell mobility serving cell change indication in the target cell (to the target network node), the UE starts to monitor a downlink physical control channel (e.g. PDCCH/CORESET) of the target cell. The downlink physical control channel carries at least one Downlink Control Information (DCI) indicating the scheduling of user plane data from the target cell to the UE.
Step 2009. The target DU determines that the UE has completed the L1/L2 based inter-cell mobility serving cell change procedure. In this example the determination is based on that the target DU receives, from the UE, a L1/L2 based inter-cell mobility serving cell change indication in the target cell. The target DU transmits, to the CU, a message, here referred to as L1/L2 based inter-cell mobility serving cell change success, indicating that the L1/L2 based inter-cell mobility serving cell change procedure has completed. In one example, the L1/L2 based inter-cell mobility serving cell change success contains a cell identity, e.g. PCI or Cell Global Identifier (CGI), and/or an indicator of L1/L2 based inter-cell mobility serving cell change, e.g., TCI state. In one example, the L1/L2 based inter-cell mobility serving cell change success is an F1 Application Protocol (F1AP) Access Success message enhanced with new IE(s), such as an explicit indicator, a TCI state, or a container including TCI state. In an alternative, the target DU transmits a message directly to the source DU indicating that the L1/L2 based inter-cell mobility serving cell change procedure has completed.
Steps 2010-2011. The serving CU receives, from the target DU, the indication that the L1/L2 based inter-cell mobility serving cell change procedure has completed. This indication may be an Access Success message (e.g., as described with reference to FIG. 13). The serving CU further transmits, to the source DU, a message, here referred to as L1/L2 based inter-cell mobility serving cell change success, indicating that that the L1/L2 based inter-cell mobility serving cell change procedure has completed. In one example, the L1/L2 based inter-cell mobility serving cell change success contains a cell identity, e.g. PCI or CGI, and/or a TCI state. In response, the serving CU transmits, to the source DU, a message indicating that that the L1/L2 based inter-cell mobility serving cell change procedure has completed. The message may include information to modify or release the UE context, i.e. whether the source cell is still to be considered a candidate target cell. In one alternative, the source DU receives a message, indicating that that the L1/L2 based inter-cell mobility serving cell change procedure has completed, directly from the target DU, provided there is a direct interface between the source DU and the target DU.

When the source DU receives the indication, it may determine that the L1/L2 based inter-cell mobility serving cell change procedure has completed, and/or modify or delete the UE context depending on the content of the received message.

In one example the L1/L2 based inter-cell mobility serving cell change success message is an F1AP UE Context Modification Request message. By sending that message the gNB-CU indicates to the source gNB-DU to stop the data transmission for the UE. The source gNB-DU also sends a Downlink Data Delivery Status frame to inform the gNB-CU about the unsuccessfully transmitted downlink data to the UE. Downlink packets, which may include PDCP PDUs not successfully transmitted in the source gNB-DU, are sent from the gNB-CU to the target gNB-DU. Downlink packets are sent to the UE. Also, uplink packets are sent from the UE, which are forwarded to the gNB-CU through the target gNB-DU. In another example the L1/L2 based inter-cell mobility serving cell change success message is an F1AP UE Context Release Request message. The gNB-CU may initiate UE Context Release procedure toward the other signalling connections or other candidate target gNB-DUs, if any, to cancel L1/L2 based inter-cell mobility change for the UE.

In one example, the source DU transmits a response message back to the CU, for example an F1AP UE Context Modification Response message.

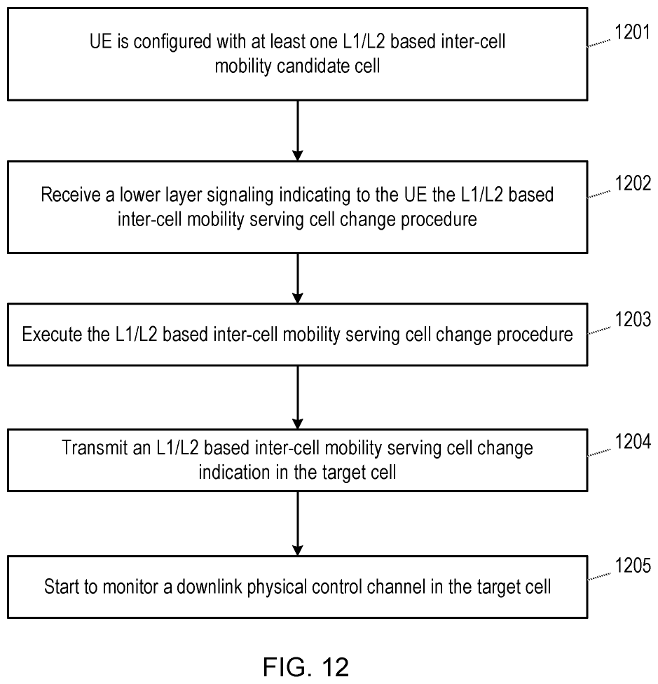

FIG. 12 is a flow chart illustrating the steps performed by the UE in one example of Approach A. Referring to FIG. 12, the main steps performed by the UE in this example are as follows.

Step 3001. The UE 1001 is connected with the source network node 1002 in the source cell 1009. The UE is configured with at least one L1/L2 based inter-cell mobility candidate cell.
Step 3002. The UE 1001 receives, from the source network node 1002, lower layer signalling indicating to the UE the L1/L2 based inter-cell mobility serving cell change procedure including an indication of the target cell 1010.
Step 3003. In response to the reception of the lower layer signalling indicating to the UE the L1/L2 based inter-cell mobility serving cell change procedure, the UE 1001 performs a L1/L2 based inter-cell mobility serving cell change procedure from the source cell 1009 to the target cell 1010.
Step 3004. The UE 1001 transmits, to the target network node 1003, a message, referred to as L1/L2 based inter-cell mobility serving cell change indication in the target cell 1010.
Step 3005. The UE 1001 starts to monitor a downlink physical control channel of the target cell. The downlink physical control channel carries at least one Downlink Control Information (DCI) indicating the scheduling of user plane data from the target cell to the UE.

### Approach B

The techniques according to Approach B are now described in more detail.

In a UE that has at least one configuration of a L1/L2 based inter-cell mobility candidate cell, the UE executes the L1/L2 based inter-cell mobility serving cell change procedure from a source cell to a target cell, and performs one or more of:
start monitoring a control channel (e.g. PDCCH, CORESET) of the target cell after a first number of time units (K1); and
transmit a scheduling request in the target cell after a second number of time units (K2).

In some embodiments, executing a L1/L2 based inter-cell mobility serving cell change procedure comprises the UE applying the lower layer signalling indicating to the UE the L1/L2 based inter-cell mobility serving cell change procedure, and starting to operate according to the configuration of the target cell, which comprises monitoring the TCI state indicated by the lower layer signalling indicating to the UE the L1/L2 based inter-cell mobility serving cell change procedure

In some embodiments, the number of time units K1 and/or K2 is configurable (e.g. in the RRC configuration for L1/L2 mobility), or they are fixed values starting from the time the UE receives and/or processes the lower layer signalling indicating to the UE the L1/L2 based inter-cell mobility serving cell change procedure. The time units may be expressed as a number of frames, subframes, slots, OFDM symbols, seconds, milliseconds, or any other time unit.

In some embodiments, K1 and/or K2 is configured per L1/L2 based inter-cell mobility candidate cell. This would enable the possibility that L1/L2 based inter-cell mobility candidate cells from the same DU of the current source cell have different values for K1 and/or K2 compared to values for the L1/L2 based inter-cell mobility candidate cells from a different DU. One benefit is that the target DU may receive an indication from the source DU (e.g. via CU) that the UE is executing the L1/L2 based inter-cell mobility serving cell change procedure, so it only starts to schedule the UE in the downlink (DL) in a control channel (e.g. PDCCH, CORESET) and/or start monitoring the uplink (UL) for scheduling requests after K1 and K2. Thus K1 and K2 should take into account the processing time at the UE after reception of the MAC CE, and possibly the delay(s) in the network interface(s), such as F1AP between source DU and source CU, and F1AP between target DU and source CU, for the target DU to be aware that the UE is executing an L1/L2 based inter-cell mobility serving cell change procedure.

In some embodiments, the UE receives, from a source network node, lower layer signalling indicating to the UE the L1/L2 based inter-cell mobility serving cell change procedure, such as a Medium Access Control layer indication, e.g. a MAC Control Element (MAC CE), or a physical layer indication, such as a Downlink Control Information (DCI), transmitted on a physical downlink control channel, PDCCH.

In some embodiments, the source network node transmits, to the target network node, or a third network node, an indication of the UE execution or UE preparation of the L1/L2 based inter-cell mobility serving cell change procedure. The indication may further include an identification of the target cell and/or the TCI state.

In a source network node (first network node), such as a source gNB (source gNB-DU), a source DU or a source CU, can control the execution of a L1/L2 based inter-cell mobility serving cell change procedure of a UE from a source cell to a target cell, and determine that the UE has completed the L1/L2 based inter-cell mobility serving cell change procedure.

In some embodiments, the source network node transmits to the UE lower layer signalling indicating to the UE the L1/L2 based inter-cell mobility serving cell change procedure, and receives an indication which means that the UE has completed the L1/L2 based inter-cell mobility serving cell change procedure.

In some embodiments, the source network node can determine that the UE has completed the serving cell change procedure by one of:
receiving, from the target network node, or a third network node, an indication that the L1/L2 based inter-cell mobility serving cell change procedure has completed. The indication may be explicit or implicit. In the case of an explicit indication, this can be modelled as a new field, bit, or structure within an existing or new message exchanged between the source cell and target cell. Otherwise, in the case of an implicit indication this can be the reception of a message itself by the target node (e.g., a message that is only used for L1/L2 based inter-cell mobility).
receiving, from the UE, an acknowledgment in response to lower layer signalling indicating to the UE the L1/L2 based inter-cell mobility serving cell change procedure, only after the L1/L2 based inter-cell mobility serving cell change procedure has been completed.

In some embodiments, the source network node can transmit, to the target network node, or a third network node, an indication of the UE execution or UE preparation of the L1/L2 based inter-cell mobility serving cell change procedure. The indication may further include an identification of the target cell and/or the TCI state.

A target network node (second network node), such as a target gNB, a target DU, or a target CU, can control the execution of a L1/L2 based inter-cell mobility serving cell change procedure of a UE from a source cell to a target cell, and determine that the UE has completed the L1/L2 based inter-cell mobility serving cell change procedure.

In some embodiments, the target network node determines that the L1/L2 based inter-cell mobility serving cell change procedure has been completed based on a scheduling request including a L1/L2 based inter-cell mobility serving cell change indication. The L1/L2 based inter-cell mobility serving cell change completion indication can be a new field, bit, or structure included in the existing scheduling request or in a new scheduling request just used for the L1/L2 based inter-cell mobility serving cell change procedure. The L1/L2 based inter-cell mobility serving cell change indication can also be a new scheduling request itself only used for the L1/L2 based inter-cell mobility serving cell change procedure.

In some embodiments, the target network node receives, from the source network node, or a third network node, an indication of a L1/L2 based inter-cell mobility serving cell change procedure for a UE. The indication may further include an identification of the target cell and/or the TCI state. In response, the target network node may transmit, after a third number of timer units (K3), in a downlink physical control channel (e.g. PDCCH/CORESET) of the target cell, at least one Downlink Control Information (DCI) indicating the scheduling of user plane data from the target cell to the UE.

A third network node (or serving network node), such as a (serving) Central Unit (CU), (serving) gNB-CU, can control the execution of a L1/L2 based inter-cell mobility serving cell change procedure of a UE from a source cell to a target cell.

In some embodiments, the third network node receives, from the source network node, an indication of a L1/L2 based inter-cell mobility serving cell change procedure for a UE. The indication may further include an identification of the target cell and/or the TCI state. In response, the third network node may transmit, to the target network node, an indication of a L1/L2 based inter-cell mobility serving cell change procedure for a UE.

### 3GPP Technical Specification Implementation

This section sets out an exemplary implementation of the solution described herein (for example the solution according to Approach A, at least) in the F1 Application Protocol (F1AP) specification, 3GPP TS 38.473 v17.0.0. In this example, the F1AP procedure and message Access Success is enhanced to be used as an indication that the UE has successfully accessed the target cell during an L1/L2 based inter-cell mobility serving cell change, and a new TCI state IE has been added to the message. Additions to 3GPP TS 38.473 v17.0.0 are marked with underline. FIG. 13 corresponds to FIG. 8.3.8.2-1 of 3GPP TS 38.473 v17.0.0 and depicts an Access Success procedure (successful operation).

### Access Success

### 8.3.8.1 General

The purpose of the Access Success procedure is to enable the gNB-DU to inform the gNB-CU of which cell the UE has successfully accessed during conditional handover or conditional PSCell addition or conditional PSCell change or L1/L2 based inter-cell mobility serving cell change. The procedure uses UE-associated signalling.

### 8.3.8.2 Successful Operation

The gNB-DU initiates the procedure by sending an ACCESS SUCCESS message. Upon reception of the ACCESS SUCCESS message, the gNB-CU shall consider that the UE successfully accessed the cell indicated by the included NR CGI IE or TCI state IE in this gNB-DU and consider all the other CHO preparations or conditional PSCell addition or conditional PSCell change preparations or L1/L2 based inter-cell mobility serving cell change preparations accepted for this UE under the same UE-associated signalling connection in this gNB-DU as cancelled.

Interaction with Other Procedure:

The gNB-CU may initiate UE Context Release procedure toward the other signalling connections or other candidate gNB-DUs for this UE, if any.

### 8.3.8.3 Abnormal Conditions

If the ACCESS SUCCESS message refers to a context that does not exist, the gNB-CU shall ignore the message.

### 9.2.2.14 Access Success

This message is sent by the gNB-DU to inform the gNB-CU of which cell the UE has successfully accessed during conditional handover or conditional PSCell addition or conditional PSCell change or L1/L2 based inter-cell mobility serving cell change.

Direction: gNB-DU→gNB-CU

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | ignore |
| gNB-CU UE F1AP ID | M | 9.3.1.4 | | YES | reject |
| gNB-DU UE F1AP ID | M | 9.3.1.5 | | YES | reject |
| NR CGI | M | 9.3.1.12 | | YES | reject |
| TCI state or an | O | | Indicates that | YES | ignore |
| explicit indicator | | | the IE is used to | | |
| | | | indicate L1/L2 | | |
| | | | based inter-cell | | |
| | | | mobility serving | | |
| | | | cell change. | | |

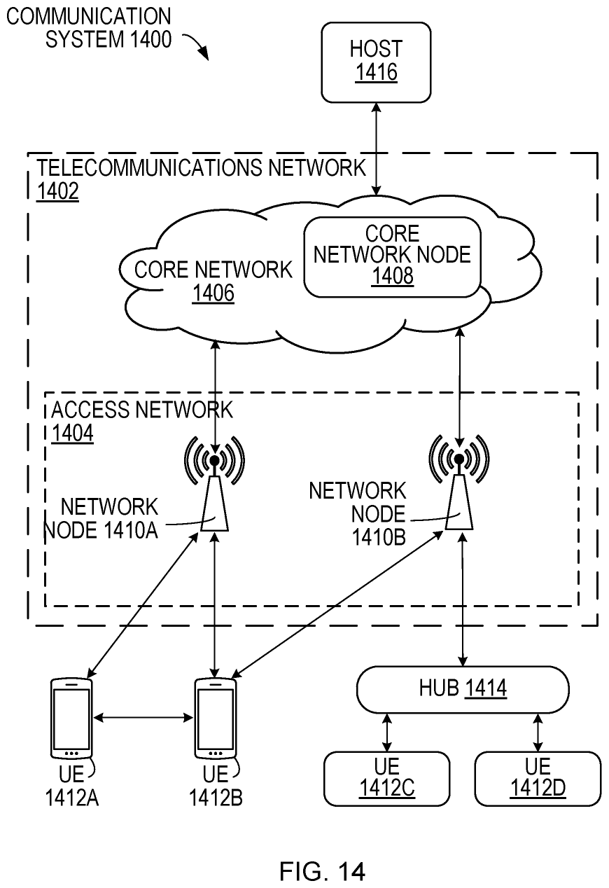

FIG. 14 shows an example of a communication system 1400 in accordance with some embodiments. In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as access network nodes 1410a and 1410b (one or more of which may be generally referred to as access network nodes 1410), or any other similar 3^{rd} Generation Partnership Project (3GPP) access node or non-3GPP access point. The access network nodes 1410 facilitate direct or indirect connection of wireless devices (also referred to interchangeably herein as user equipment (UE)), such as by connecting UEs 1412a, 1412b, 1412c, and 1412d (one or more of which may be generally referred to as UEs 1412) to the core network 1406 over one or more wireless connections. The access network nodes 1410 may be, for example, access points (APs) (e.g. radio access points), base stations (BSs) (e.g. radio base stations, Node Bs, evolved Node Bs (eNBs) and NR NodeBs (gNBs)).

Unless otherwise indicated, the term ‘network node’ is used herein to refer to both access network nodes 1410 and core network nodes 1408

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The wireless devices/UEs 1412 may be any of a wide variety of communication devices, including wireless devices arranged, configured, and/or operable to communicate wirelessly with the network nodes 1410 and other communication devices. Similarly, the access network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the access network nodes 1410 to one or more hosts, such as host 1416. These connections may be direct or indirect via one or more intermediary networks or devices. In other examples, network nodes may be directly coupled to hosts. The core network 1406 includes one more core network nodes (e.g. core network node 1408) that are structured with hardware and software components. Features of these components may be substantially similar to those described with respect to the wireless devices/UEs, access network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server. As a whole, the communication system 1400 of FIG. 14 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 14, the hub 1414 communicates with the access network 1404 to facilitate indirect communication between one or more UEs (e.g. UE 1412c and/or 1412d) and access network nodes (e.g. access network node 1410b). In some examples, the hub 1414 may be a controller, router, a content source and analytics node, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g. UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

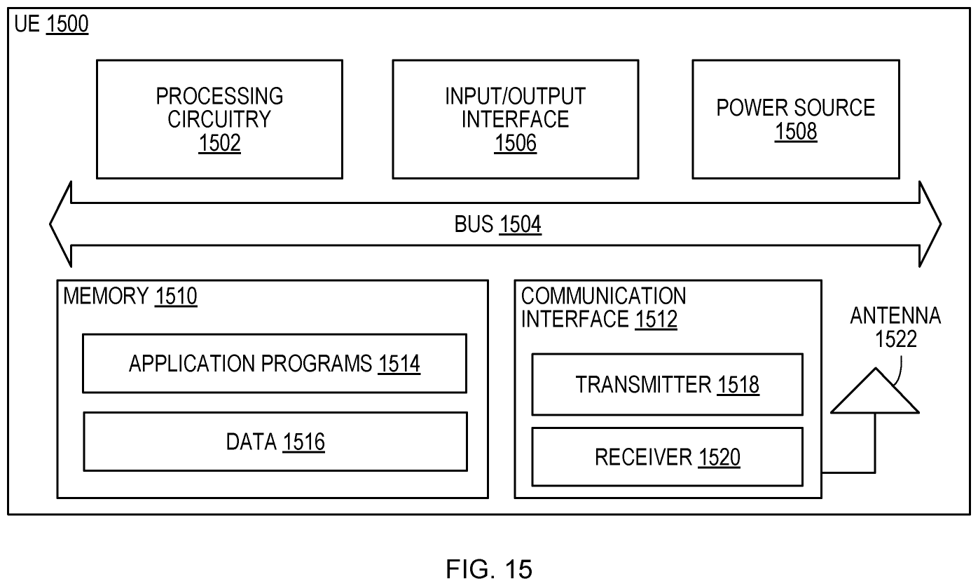

FIG. 15 shows a wireless device or UE 1500 in accordance with some embodiments.

As used herein, a UE refers to a device capable, configured, arranged and/or operable to communicate wirelessly with network nodes and/or other UEs. Examples of a wireless device/UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs). The processing circuitry 1502 may be operable to provide, either alone or in conjunction with other UE 1500 components, such as the memory 1510, to provide UE 1500 functionality.

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g. an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g. another UE or a network node in an access network). Each transceiver may include a transmitter 1518 and/or a receiver 1520 appropriate to provide network communications (e.g. optical, electrical, frequency allocations, and so forth). Moreover, the transmitter 1518 and receiver 1520 may be coupled to one or more antennas (e.g. antenna 1522) and may share circuit components, software or firmware, or alternatively be implemented separately.

In some embodiments, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

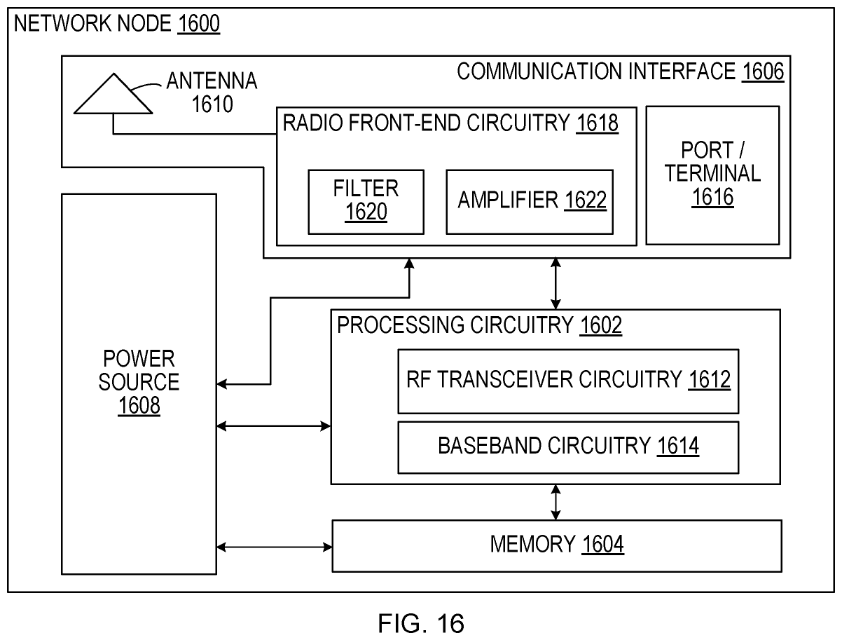

FIG. 16 shows a network node 1600 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)). Other examples of network nodes include, but are not limited to, core network nodes such as nodes that include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1600 includes processing circuitry 1602, a memory 1604, a communication interface 1606, and a power source 1608, and/or any other component, or any combination thereof. The network node 1600 may be composed of multiple physically separate components (e.g. a NodeB component and a RNC component, or a BTS component and a BSC component, etc.), which may each have their own respective components. In certain scenarios in which the network node 1600 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g. separate memory 1604 for different RATs) and some components may be reused (e.g. a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signalling and/or data between network nodes, the access network, the core network, and/or a UE. As illustrated, the communication interface 1606 comprises port(s)/terminal(s) 1616 to send and receive data, for example to and from a network over a wired connection.

In embodiments where the network node 1600 is an access network node, the communication interface 1606 also includes radio front-end circuitry 1618 that may be coupled to, or in certain embodiments a part of, the antenna 1610. In embodiments where the network node 1600 is a core network node, the core network node may not include radio front-end circuitry 1618 and antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the access network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g. at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g. the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

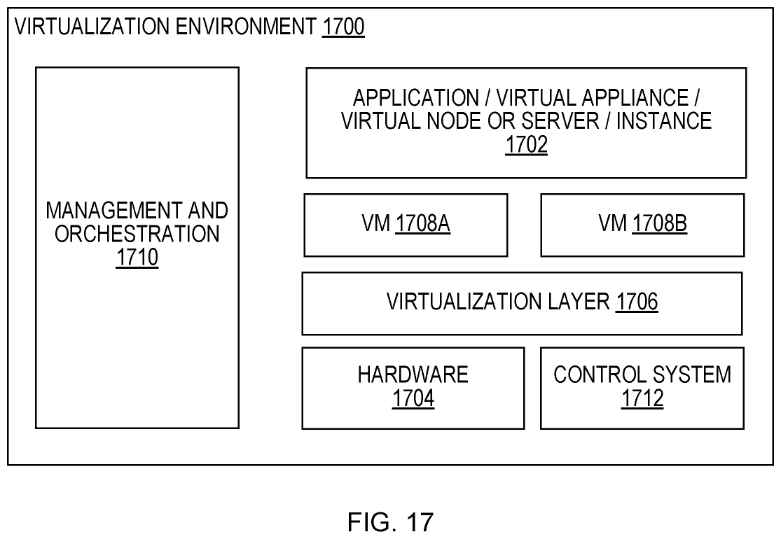

FIG. 17 is a block diagram illustrating a virtualization environment 1700 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as an access network node, a wireless device/UE, a core network node, or host. Further, in embodiments in which the virtual node does not require radio connectivity (e.g. a core network node or host), then the node may be entirely virtualized.

Applications 1702 (which may alternatively be called software instances, virtual appliances, network functions, virtual nodes, virtual network functions, etc.) are run in the virtualization environment 1700 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1712 which may alternatively be used for communication between hardware nodes and radio units.

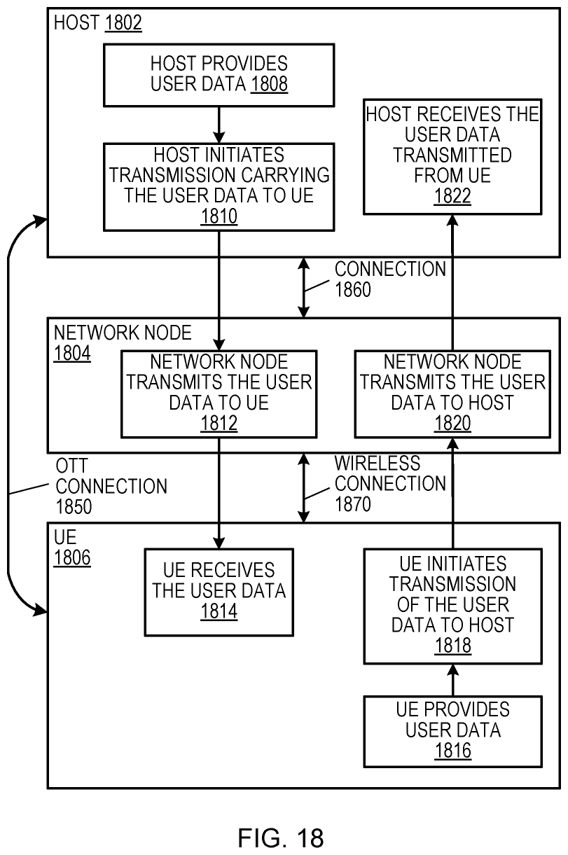

FIG. 18 shows a communication diagram of a host 1802 communicating via a network node 1804 with a UE 1806 over a partially wireless connection in accordance with some embodiments.

Example implementations, in accordance with various embodiments, of the UE (such as a UE 1412A of FIG. 14 and/or UE 1500 of FIG. 15), network node (such as network node 1410A of FIG. 14 and/or network node 1600 of FIG. 16), and host (such as host 1416 of FIG. 14 and/or host 1700 of FIG. 17) discussed in the preceding paragraphs will now be described with reference to FIG. 18.

Like host 1700, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1406 of FIG. 14) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804.

In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may enable a data transfer to start as soon as the UE has started to receive the downlink beam as indicated by lower layer signalling that indicated the L1/L2 based inter-cell mobility serving cell change procedure, and thereby provide benefits such as reduced disruption to user content and reduced user waiting time.

In an example scenario, factory status information may be collected and analysed by the host 1802. As another example, the host 1802 may process audio and video data which may have been retrieved from a UE for use in creating maps. As another example, the host 1802 may collect and analyse real-time data to assist in controlling vehicle congestion (e.g. controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analysing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signalling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g. UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to device numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### EMBODIMENTS

### Group A Embodiments

1. A method performed by a user equipment, UE, the method comprising:
executing a serving cell change procedure from a source cell provided by a first network node to a target cell provided by a second network node, wherein the serving cell change procedure is performed using lower layer signalling; and
in response to executing the serving cell change procedure, performing one or more of:
(i) transmitting a serving cell change indication to the second network node indicating that the serving cell change has been executed;
(ii) monitoring a downlink control channel in the target cell for scheduling of user data in a downlink to the UE; and
(iii) transmitting a scheduling request in the target cell for scheduling of user data in an uplink from the UE.
   2. The method of Embodiment 1, further comprising the step of:
receiving lower layer signalling relating to the serving cell change procedure to enable the UE to execute the serving cell change procedure; and
sending a feedback message to the first network node after receiving the lower layer signalling relating to the serving cell change procedure.
   3. The method of Embodiment 2, wherein the feedback message is a Hybrid Automatic Repeat Request, HARQ, message.
   4. The method of any of the previous Embodiments, wherein the serving cell change indication is sent using lower layer signalling.
   5. The method of any of the previous Embodiments, wherein the serving cell change indication is a Medium Access Control, MAC, Control Element, CE; a Random Access, RA, preamble; a Scheduling Request, SR; a channel state information, CSI, report; or a Sounding Reference Signal, SRS.
   6. The method of any of the previous Embodiments, wherein the monitoring of the downlink control channel is started a predetermined time period, K1, after executing the serving cell change procedure.
   7. The method of any of the previous Embodiments, wherein the scheduling request is transmitted a predetermined time period, K2, after executing the serving cell change procedure.
   8. The method of any of the previous Embodiments, wherein monitoring the downlink control channel comprises monitoring for Downlink Control Information, DCI.
   9. The method of any of the previous Embodiments, wherein in response to executing the serving cell change procedure, the UE performs (i) and (ii).
   10. The method of any of Embodiments 1-8, wherein in response to executing the serving cell change procedure, the UE performs (ii) and (iii).
   11. The method of any of the previous Embodiments, wherein the lower layer signalling is a Physical Layer and/or a Medium Access Control, MAC, Layer.
   12. The method of any of the previous Embodiments, wherein the lower layer signalling is Layer 1 and/or Layer 2 signalling.
   13. The method of any of the previous Embodiments, wherein the lower layer signalling is signalling in a layer below a Radio Resource Control, RRC, layer.
   14. The method of any preceding embodiment, further comprising:
providing user data; and
forwarding the user data to a host via the transmission to the network node.

### Group B Embodiments

15. A method performed by a first network node, the method comprising:
determining whether a user equipment, UE, has executed a serving cell change procedure from a source cell provided by the first network node to a target cell provided by a second network node, wherein the serving cell change procedure is performed using lower layer signalling.
   16. The method of Embodiment 15, wherein the step of determining comprises determining that the UE has executed the serving cell change procedure if:
(i) an indication is received from the second network node or a third network node that the serving cell change procedure has been completed; or
(ii) a feedback message is received from the UE that indicates that the UE has received lower layer signalling relating to the serving cell change procedure.
   17. The method of Embodiment 16, wherein the feedback message is a Hybrid Automatic Repeat Request, HARQ, message.
   18. The method of any of Embodiments 15-17, wherein the method further comprises:
sending lower layer signalling relating to the serving cell change procedure to enable the UE to execute the serving cell change procedure.
   19. The method of any of Embodiments 15-18, wherein the lower layer signalling is a Physical Layer and/or a Medium Access Control, MAC, Layer.
   20. The method of any of Embodiments 15-19, wherein the lower layer signalling is Layer 1 and/or Layer 2 signalling.
   21. The method of any of Embodiments 15-20, wherein the lower layer signalling is signalling in a layer below a Radio Resource Control, RRC, layer.
   22. The method of any of the previous embodiments, further comprising:
obtaining user data; and
forwarding the user data to a host or a user equipment.

### Group C Embodiments

23. A method performed by a second network node, the method comprising:
determining whether a user equipment, UE, has executed a serving cell change procedure from a source cell provided by a first network node to a target cell provided by the second network node, wherein the serving cell change procedure is performed using lower layer signalling.
   24. The method of Embodiment 23, wherein the step of determining comprises determining that the UE has executed the serving cell change procedure if:
(i) a serving cell change indication is received from the UE indicating that the serving cell change has been executed; or
(ii) a scheduling request is received from the UE to schedule user data in an uplink from the UE; or
(iii) an indication is received from a third network node indicating that the serving cell change has been executed.
   25. The method of Embodiment 24, wherein the serving cell change indication is sent using lower layer signalling.
   26. The method of Embodiment 24 or 25, wherein the serving cell change indication is a Medium Access Control, MAC, Control Element, CE; a Random Access, RA, preamble; a Scheduling Request, SR; a channel state information, CSI, report; or a Sounding Reference Signal, SRS.
   27. The method of any of Embodiments 24-26, wherein the scheduling request is received a predetermined time period, K2, after executing the serving cell change procedure.
   28. The method of any of Embodiments 23-27, wherein the method further comprises:
transmitting an indication to the third network node indicating that the serving cell change has been executed.
   29. The method of any of Embodiments 23-28, wherein the method further comprises:
transmitting a downlink control channel to the UE for scheduling of user data in a downlink to the UE.
   30. The method of Embodiment 29, wherein the downlink control channel comprises Downlink Control Information, DCI.
   31. The method of Embodiment 29 or 30, wherein the downlink control channel is transmitted to the UE a predetermined time period, K3, after determining that the UE has executed the serving cell change procedure.
   32. The method of any of Embodiments 23-31, wherein the lower layer signalling is a Physical Layer and/or a Medium Access Control, MAC, Layer.
   33. The method of any of Embodiments 23-32, wherein the lower layer signalling is Layer 1 and/or Layer 2 signalling.
   34. The method of any of Embodiments 23-33, wherein the lower layer signalling is signalling in a layer below a Radio Resource Control, RRC, layer.
   35. The method of any of the previous embodiments, further comprising:
obtaining user data; and
forwarding the user data to a host or a user equipment.

### Group D Embodiments

36. A method performed by a third network node, the method comprising:

determining whether a user equipment, UE, has executed a serving cell change procedure from a source cell provided by a first network node to a target cell provided by a second network node, wherein the serving cell change procedure is performed using lower layer signalling.

37. The method of Embodiment 36, wherein the step of determining comprises determining that the UE has executed the serving cell change procedure if:
(i) an indication is received from the first network node indicating that the serving cell change has been executed; or
(ii) an indication is received from the second network node indicating that the serving cell change has been executed.
   38. The method of Embodiment 37, wherein if it is determined that the UE has executed the serving cell change procedure due to an indication being received from the first network node, the method further comprises:
   sending an indication to the second network node indicating that the serving cell change has been executed.
   39. The method of any of Embodiments 37 or 38, wherein the serving cell change indication is received using lower layer signalling.
   40. The method of any of Embodiments 37-39, wherein the serving cell change indication is a Medium Access Control, MAC, Control Element, CE; a Random Access, RA, preamble; a Scheduling Request, SR; a channel state information, CSI, report; or a Sounding Reference Signal, SRS.
   41. The method of any of Embodiments 36-40, wherein if it is determined that the UE has executed the serving cell change procedure, the method further comprises:

sending user data for the UE to the second network node.

42. The method of any of Embodiments 36-41, wherein the lower layer signalling is a Physical Layer and/or a Medium Access Control, MAC, Layer.
43. The method of any of Embodiments 36-42, wherein the lower layer signalling is Layer 1 and/or Layer 2 signalling.
44. The method of any of Embodiments 36-43, wherein the lower layer signalling is signalling in a layer below a Radio Resource Control, RRC, layer.
45. The method of any of the previous embodiments, further comprising:
obtaining user data; and
forwarding the user data to a host or a user equipment.

### Group E Embodiments

46. A computer program product comprising a computer readable medium having computer readable code embodied therein, the computer readable code being configured such that, on execution by a suitable computer or processor, the computer or processor is caused to perform the method of any of the Group A embodiments or the Group B embodiments.
47. A user equipment, UE, configured to perform the method of any of the Group A embodiments.
48. A user equipment, UE, comprising a processor and a memory, said memory containing instructions executable by said processor whereby said UE is operative to perform the method of any of the Group A embodiments.
49. A first radio access network, RAN, node, configured to perform the method of any of the Group B, C and/or D embodiments.
50. A first radio access network, RAN, node comprising a processor and a memory, said memory containing instructions executable by said processor whereby said first RAN node is operative to perform the method of any of the Group B, C and/or D embodiments.
51. A user equipment, comprising:

processing circuitry configured to cause the user equipment to perform any of the steps of any of the Group A embodiments; and
power supply circuitry configured to supply power to the processing circuitry.
   52. A network node, the network node comprising:
processing circuitry configured to cause the network node to perform any of the steps of any of the Group B, C and/or D embodiments;
power supply circuitry configured to supply power to the processing circuitry.
   53. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   54. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.
   55. The host of the previous embodiment, wherein the cellular network further includes a network node configured to communicate with the UE to transmit the user data to the UE from the host.
   56. The host of the previous 2 embodiments, wherein:
the processing circuitry of the host is configured to execute a host application, thereby providing the user data; and
the host application is configured to interact with a client application executing on the UE, the client application being associated with the host application.
   57. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.
   58. The method of the previous embodiment, further comprising:
at the host, executing a host application associated with a client application executing on the UE to receive the user data from the UE.
   59. The method of the previous embodiment, further comprising:
at the host, transmitting input data to the client application executing on the UE, the input data being provided by executing the host application,
wherein the user data is provided by the client application in response to the input data from the host application.
   60. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.
   61. The host of the previous embodiment, wherein the cellular network further includes a network node configured to communicate with the UE to transmit the user data from the UE to the host.
   62. The host of the previous 2 embodiments, wherein:
the processing circuitry of the host is configured to execute a host application, thereby providing the user data; and
the host application is configured to interact with a client application executing on the UE, the client application being associated with the host application.
   63. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.
   64. The method of the previous embodiment, further comprising:
at the host, executing a host application associated with a client application executing on the UE to receive the user data from the UE.
   65. The method of the previous embodiment, further comprising:
at the host, transmitting input data to the client application executing on the UE, the input data being provided by executing the host application,
wherein the user data is provided by the client application in response to the input data from the host application.
   66. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B, C and/or D embodiments to transmit the user data from the host to the UE.
   67. The host of the previous embodiment, wherein:
the processing circuitry of the host is configured to execute a host application that provides the user data; and
the UE comprises processing circuitry configured to execute a client application associated with the host application to receive the transmission of user data from the host.
   68. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.
   69. The method of the previous embodiment, further comprising, at the network node, transmitting the user data provided by the host for the UE.
   70. The method of any of the previous 2 embodiments, wherein the user data is provided at the host by executing a host application that interacts with a client application executing on the UE, the client application being associated with the host application.
   71. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B, C and/or D embodiments to transmit the user data from the host to the UE.
   72. The communication system of the previous embodiment, further comprising:
the network node; and/or
the user equipment.
   73. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B, C and/or D embodiments to receive the user data from a user equipment (UE) for the host.
   74. The host of the previous 2 embodiments, wherein:
the processing circuitry of the host is configured to execute a host application, thereby providing the user data; and
the host application is configured to interact with a client application executing on the UE, the client application being associated with the host application.
   75. The host of the any of the previous 2 embodiments, wherein the initiating receipt of the user data comprises requesting the user data.
   76. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B, C and/or D embodiments to receive the user data from the UE for the host.
   77. The method of the previous embodiment, further comprising at the network node, transmitting the received user data to the host.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | 3rd Generation Partnership Project |
| 5G | 5th Generation |
| 5GC | 5G Core |
| 6G | 6th Generation |
| ABS | Almost Blank Subframe |
| ACK | Acknowledgement |
| AGC | Automatic Gain Control |
| AMF | Access and Mobility Function |
| AP | Application Protocol |
| ARQ | Automatic Repeat Request |
| AWGN | Additive White Gaussian Noise |
| BCCH | Broadcast Control Channel |
| BCH | Broadcast Channel |
| BSR | Buffer Status Report |
| BWP | Bandwidth Part |
| CA | Carrier Aggregation |
| CC | Carrier Component |
| CCCH SDU | Common Control Channel SDU |
| CDMA | Code Division Multiplexing Access |
| CE | Control Element |
| CGI | Cell Global Identifier/Identity |
| CHO | Conditional Handover |
| CIR | Channel Impulse Response |
| CN | Core Network |
| CP | Cyclic Prefix |
| CP | Control Plane |
| CPA | Conditional PSCell Addition |
| CPC | Conditional PSCell Change |
| CPICH | Common Pilot Channel |
| CPICH | Ec/No CPICH Received energy per chip |
| | divided by the power density in the band |
| CQI | Channel Quality information/Indicator |
| C-RNTI | Cell RNTI |
| CSI | Channel State Information |
| CU | Central Unit |
| DC | Dual Connectivity |
| DCCH | Dedicated Control Channel |
| DCI | Downlink Control Information |
| DL | Downlink |
| DM | Demodulation |
| DMRS | Demodulation Reference Signal |
| DRB | Data Radio Bearer |
| DRX | Discontinuous Reception |
| DTX | Discontinuous Transmission |
| DTCH | Dedicated Traffic Channel |
| DU | Distributed Unit |
| DUT | Device Under Test |
| E-CID | Enhanced Cell-ID (positioning method) |
| eMBMS | evolved Multimedia Broadcast Multicast |
| | Services |
| E-SMLC | Evolved-Serving Mobile Location Centre |
| ECGI | Evolved CGI |
| eNB | E-UTRAN NodeB |
| ePDCCH | Enhanced Physical Downlink Control |
| | Channel |
| E-RAB | EUTRAN Radio Access Bearer |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| GTP-U | GPRS Tunnelling Protocol - User Plane |
| HARQ | Hybrid Automatic Repeat Request |
| HO | Handover |
| HSPA | High Speed Packet Access |
| HRPD | High Rate Packet Data |
| IE | Information Element |
| IP | Internet Protocol |
| L1 | Layer 1 |
| L2 | Layer 2 |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service |
| | Single Frequency Network |
| MBSFN ABS | MBSFN Almost Blank Subframe |
| MCG | Master Cell Group |
| MDT | Minimization of Drive Tests |
| MeNB | Master eNB |
| MgNB | Master gNB |
| MIB | Master Information Block |
| MME | Mobility Management Entity |
| MN | Master Node |
| MR-DC | Multi-Radio Dual Connectivity |
| MSC | Mobile Switching Center |
| NACK | Negative Acknowledgement |
| NAS | Non-Access Stratum |
| NG-eNB | Next Generation eNB |
| NG-RAN | Next Generation RAN |
| NPDCCH | Narrowband Physical Downlink Control |
| | Channel |
| NR | New Radio |
| OCNG | OFDMA Channel Noise Generator |
| OFDM | Orthogonal Frequency Division Multiplexing |
| OFDMA | Orthogonal Frequency Division Multiple |
| | Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PCI | Physical Cell Identity |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PHR | Power headroom Report |
| PLMN | Public Land Mobile Network |
| PMI | Precoder Matrix Indicator |
| PRACH | Physical Random Access Channel |
| PRS | Positioning Reference Signal |
| PSCell | Primary Secondary Cell in LTE or Primary |
| | SCG cell in NR |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| QCI | Quasi-Co-Location |
| RAN | Radio Access Network |
| RAT | Radio Access Technology |
| RB | Radio Bearer |
| RLC | Radio Link Control |
| RLF | Radio Link Failure |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SCG | Secondary Cell Group |
| SCTP | Stream Control Transmission Protocol |
| SDAP | Service Data Adaptation Protocol |
| SDU | Service Data Unit |
| SeNB | Secondary eNB |
| SgNB | Secondary gNB |
| SFN | System Frame Number |
| SGW | Serving Gateway |
| SI | System Information |
| SIB | System Information Block |
| SINR | Signal to Interference plus Noise Ratio |
| SN | Secondary Node |
| SNR | Signal to Noise Ratio |
| SON | Self Optimized Network |
| SpCell | Special Cell, the PCell of a MCG or SCG |
| SR | Scheduling Request |
| SRB | Signalling Radio Bearer |
| SRS | Sounding Reference Signal |
| SS | Synchronization Signal |
| SSB | Synchronisation Signal Block |
| S-SN | Source Secondary Node |
| SSS | Secondary Synchronization Signal |
| SUL | Supplementary Uplink |
| TAT | Time Alignment Timer |
| TCI | Transmission Configuration Indication |
| TDD | Time Division Duplex |
| TDOA | Time Difference of Arrival |
| TEID | Tunnel Endpoint Identifier |
| TNL | Transport Network Layer |
| TOA | Time of Arrival |
| T-SN | Target Secondary Node |
| TSS | Tertiary Synchronization Signal |
| TTI | Transmission Time Interval |
| UCI | Uplink Control Information |
| UDP | User Datagram Protocol |
| UE | User Equipment |
| UL | Uplink |
| UL-SCH | Uplink Shared Channel |
| UP | User Plane |
| UPF | User Plane Function |
| URLLC | Ultra Reliable Low Latency Communication |
| USIM | Universal Subscriber Identity Module |
| UTDOA | Uplink Time Difference of Arrival |
| WCDMA | Wide CDMA |
| WLAN | Wide Local Area Network |
| X2 | Interface between base stations |

1-66. (canceled)

67. A method performed by a first network node, the method comprising: determining whether a user equipment (UE) has executed a Layer 1/Layer 2 (L1/L2) based inter-cell mobility serving cell change procedure from a source cell provided by the first network node to a target cell provided by a second network node, wherein the step of determining comprises determining that the UE has executed the L1/L2 based inter-cell mobility serving cell change procedure responsive to:
receiving an indication from the second network node or a third network node, indicating that the serving cell change procedure has been completed; or
receiving a feedback message from the UE, indicating that indicates that the UE has received lower layer signalling relating to the serving cell change procedure.

68. The method of claim 67, wherein the feedback message is a Hybrid Automatic Repeat Request (HARQ) message.

69. The method of claim 67, comprising transmitting, to the third network node, an indication of L1/L2 inter-cell mobility, said indication includes an identification of the target cell and/or a Transmission Configuration Indication (TCI) state.

70. The method of claim 67, wherein the first network node is a source Digital Unit (DU).

71. A method performed by a second network node, the method comprising:
determining whether a user equipment (UE) has executed a Layer 1/Layer 2 (L1/L2) based inter-cell mobility serving cell change procedure from a source cell provided by a first network node to a target cell provided by the second network node, wherein the step of determining comprises determining that the UE has executed the L1/L2 based inter-cell mobility serving cell change procedure responsive to receiving a L1/L2 based inter-cell mobility serving cell change indication from the UE, indicating that the L1/L2 based inter-cell mobility serving cell change has been executed, and wherein the L1/L2 based inter-cell mobility serving cell change indication is a scheduling request (SR), which is sent using lower layer signalling.

72. The method of claim 71, wherein the scheduling request is received a predetermined time period, after executing the serving cell change procedure.

73. The method of claim 71, wherein the method further comprises:
transmitting an indication to a third network node indicating that the serving cell change has been executed.

74. The method of claim 71, wherein the indication transmitted to the third network node is an Access Success message.

75. The method of claim 71, wherein the second network node is a target Digital Unit (DU).

76. The method of claim 71, wherein the method further comprises:
transmitting a downlink control channel to the UE for scheduling of user data in a downlink to the UE.

77. The method of claim 76, wherein the downlink control channel is transmitted to the UE a predetermined time period, after determining that the UE has executed the serving cell change procedure.

78. A method performed by a third network node, the method comprising:
determining whether a user equipment (UE) has executed a Layer 1/Layer 2 (L1/L2) based inter-cell mobility serving cell change procedure from a source cell provided by a first network node to a target cell provided by a second network node, wherein the L1/L2 based inter-cell mobility serving cell change procedure is performed using lower layer signalling;
wherein the step of determining comprises determining that the UE has executed the L1/L2 based inter-cell mobility serving cell change procedure responsive to receiving an indication from the first network node, indicating that the L1/L2 based inter-cell mobility serving cell change has been executed, or receiving an indication from the second network node, indicating that the L1/L2 based inter-cell mobility serving cell change has been executed.

79. The method of claim 78, wherein the indication from the first network node includes at least one of an identification of the target cell or a Transmission Configuration Indication (TCI) state.

80. The method of claim 78, wherein the indication received from the second network node is an Access Success message.

81. The method of claim 78, wherein the third network node is a serving Central Unit (CU).

82. The method of claim 78, wherein, responsive to receiving the indication from the second network node, the method further comprises sending an indication to the first network node, indicating that the L1/L2 based inter-cell mobility serving cell change has been executed.

83. The method of claim 78, wherein, responsive to receiving the indication from the first network node, the method further comprises sending an indication to the second network node, indicating that the L1/L2 based inter-cell mobility serving cell change has been executed.

84. The method of claim 78, wherein, responsive to determining that the UE has executed the L1/L2 based inter-cell mobility serving cell change procedure, the method further comprises sending user data for the UE to the second network node.

85. A first network node comprising:
a processor; and
a memory, wherein the memory contains instructions executable by the processor whereby the first network node is operative to:
determine whether a user equipment (UE) has executed a Layer 1/Layer 2 (L1/L2) based inter-cell mobility serving cell change procedure from a source cell provided by the first network node to a target cell provided by a second network node;
wherein the step of determining comprises determining that the UE has executed the L1/L2 based inter-cell mobility serving cell change procedure responsive to:
receiving an indication from the second network node or a third network node, indicating that the serving cell change procedure has been completed; or
receiving a feedback message from the UE, indicating that that the UE has received lower layer signalling relating to the L1/L2 based inter-cell mobility serving cell change procedure.

86. A second network node comprising:
a processor; and
a memory, the memory containing instructions executable by the processor whereby the second network node is operative to:
determine whether a user equipment (UE) has executed a Layer 1/Layer 2 (L1/L2) based inter-cell mobility serving cell change procedure from a source cell provided by a first network node to a target cell provided by the second network node;
wherein the step of determining comprises determining that the UE has executed the L1/L2 based inter-cell mobility serving cell change procedure responsive to receiving a L1/L2 based inter-cell mobility serving cell change indication from the UE, indicating that the L1/L2 based inter-cell mobility serving cell change has been executed, and wherein the L1/L2 based inter-cell mobility serving cell change indication is a scheduling request (SR), which is sent using lower layer signalling.

87. A third network node comprising:
a processor; and
a memory, the memory containing instructions executable by the processor whereby the third network node is operative to:
determine whether a user equipment (UE) has executed a Layer 1/Layer 2 (L1/L2) based inter-cell mobility serving cell change procedure from a source cell provided by a first network node to a target cell provided by a second network node, wherein the L1/L2 based inter-cell mobility serving cell change procedure is performed using lower layer signalling; and
wherein the step of determining comprises determining that the UE has executed the L1/L2 based inter-cell mobility serving cell change procedure responsive to:
receiving an indication from the first network node, indicating that the L1/L2 based inter-cell mobility serving cell change has been executed; or
receiving an indication from the second network node, indicating that the L1/L2 based inter-cell mobility serving cell change has been executed.
